(19) United States
(12) Patent Application Publication
(10) Pub. No.: US 2010/0253285 A1
(43) Pub. Date: Oct. 7, 2010

(54) BATTERY PACK AND CHARGING METHOD

(75) Inventors: Tsukasa Takahashi, Fukushima (JP); Bunya Sato, Saitama (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/725,109

(22) Filed: Mar. 16, 2010

(30) Foreign Application Priority Data
Apr. 3, 2009 (JP) P2009-090983

(51) Int. Cl. H02J 7/04; H02J 7/00; G01N 27/416

(52) U.S. Cl. 320/118; 320/162; 320/134; 324/433; 324/431; 320/163

(57) ABSTRACT

A battery pack includes one or a plurality of secondary batteries that are connected with each other; a positive pole terminal and a negative pole terminal to which external equipment is connected; a variable resistance portion which is connected between a positive pole of the secondary battery and the positive pole terminal or between a negative pole of the secondary battery and the negative pole terminal and resistance values of which are changed; a battery voltage measuring portion for measuring the voltage of the secondary battery; and a controlling portion for controlling the resistance value of the variable resistance portion based on the measurement result of the battery voltage measuring portion.

### CROSS REFERENCES TO RELATED APPLICATIONS

The present application claims priority to Japanese Priority Patent Application JP 2009-090983 filed in the Japan Patent Office on Apr. 3, 2009, the entire content of which is hereby incorporated by reference.

### BACKGROUND

The present application relates to a battery pack and a charging method capable of detecting an overcharge state.

Recently, as power supplies of various electronic equipments, lithium ion secondary batteries having advantages such as high output, high energy density, compactness and lightweight are widely used. Since the lithium ion secondary battery has a high energy density as compared with other secondary batteries that use a nickel-cadmium and a nickel-hydrogen, for example, it is very important to sufficiently secure the safety of the battery. For that reason, on a battery pack that uses the lithium ion secondary battery, there are usually mounted a protective circuit and a protective IC (Integrated Circuit) that detect an over-charge and an over-discharge or the like so as to prevent a charge and a discharge.

FIG. 45 shows a structure of one example of a battery pack 100 of related art. The battery pack 100 includes a secondary battery (hereinafter, simply referred to as a battery) 101, a protective circuit 102, a microcomputer 103, a charging control FET 104, a discharging control FET 105 and a cell balance circuit 106. As one example, two batteries 101 are connected in series with each other. The battery pack 100 is installed in a voltage supplying portion 200 at the time of charging, and a positive pole terminal 109 and a negative pole terminal 110 are each connected to a positive pole terminal and a negative pole terminal of the voltage supplying portion, whereby the charging is performed.

The protective circuit 102 measures the respective voltages of the batteries 101, detects an over-charge state and an over-discharge state based on the measurement result, and controls the charging control FET 104 and the discharging control FET 105 based on the detection results. When the battery voltage becomes an over-charge detection voltage, the charging control FET 104 is OFF to ensure that a charging current does not flow. When the battery voltage becomes an over-discharge detection voltage, the discharging control FET 105 is OFF, so that a discharging current does not flow.

Furthermore, the protective circuit 102 provides the microcomputer 103 with the measured voltage of the battery 101. The microcomputer 103 judges whether or not the cell balance is collapsed by means of the supplied voltage of the battery 101. If it is judged that the cell balance is collapsed, an ON/OFF of a switch 107 of the cell balance circuit 106 which is connected in parallel to the battery 101 is controlled and the battery 101 at the side having a high cell voltage is discharged via a resistance 108.

As described above, a technique, in which the voltage of the battery is measured, the over-charge state is detected based on the measurement result and the charge and discharge control FET is controlled according to the detection results, is described in Japanese Patent Application Laid-open No. 2008-295250.

In general, the battery pack that uses the battery of the lithium ion secondary battery is charged so that the voltage of the battery becomes 4.2 V (volts). For example, in an example shown in FIG. 45, when the charging voltage from the voltage supplying portion is 8.4 V±0.1 V, the maximum value of the voltage applied to the battery 101 is 4.25 V. In practice, in a correction by the cell balance circuit 106, there is a deviation in the degrees of the voltage measurement precision of the microcomputer 103 so that it is difficult to completely equalize the voltage of the battery 101. Thus, even when the charging voltage is 8.4 V±0.1 V, voltage higher than a maximum of 4.25 V is likely applied for each battery. Thus, it has been difficult to perform a control in which the voltage to be applied for each battery is 4.25 V at most.

### SUMMARY

A revision of Electrical Appliance and Material Safety Law is scheduled in the near future. In the revision of the Electrical Appliance and Material Safety Law, for the purpose of more fully securing the safety of the battery, it is regulated so that the charging voltage applied to each battery is equal to or less than 4.25 V. From now, it is necessary to execute countermeasures in which the voltage of each battery does not exceed 4.25 V.

As one method of the countermeasures, there is disclosed a method of newly designing a charger that generates the charging voltage so that the voltage applied to the battery does not exceed 4.25 V. However, in a case where the charging is performed by the use of a charger of the related art, as described above, since the voltage applied to the battery exceeds 4.25 V, it is difficult to use the charger of the related art.

As another countermeasure, it is considered that the degree of the precision of the protective circuit in the battery pack is improved so as to set the over-charge detection voltage to be equal to or less than 4.25 V. Even when an IC with a high degree of the precision is used, the over-charge protection of 4.24 V±0.01 V is controlled. In this case, when the voltage applied to the battery is 4.23 V, it is judged to be the over-charge. As a result, there is a problem in which an over-charge protection is performed despite a normal charging state. When the charging control FET 104 is OFF due to the over-charge protection, normally, an alarm goes off as a charging abnormality. As described above, it is undesirable that the alarm goes off in the normal charging state.

Thus, it is desirable to provide a battery pack and a charging method thereof in which the charging can be performed so that the voltage to be applied to the battery is equal to or less than the over-charge detection voltage.

According to an embodiment of the present application, there is provided a battery pack which includes one or a plurality of secondary batteries connected with each other, a positive pole terminal and a negative pole terminal to which external equipment is connected, a variable resistance portion which is connected between the positive pole of the secondary battery and the positive pole terminal or between the negative pole of the secondary battery and the negative pole terminal and resistance values of which are changed, a battery voltage measuring portion for measuring the voltage of the secondary battery, and a controlling portion for controlling the resistance value of the variable resistance portion based on the measurement result of the battery voltage measuring portion.

According to an embodiment, there is provided a battery pack which includes one or a plurality of secondary batteries connected with each other, a positive pole terminal and a negative pole terminal to which external equipment is connected, a first switch which is connected between the positive pole of the secondary battery and the positive pole terminal or between the negative pole of the secondary battery and the negative pole terminal, a first resistance portion connected in parallel to the first switch, a battery voltage measuring portion for measuring the voltage of the secondary battery, and a controlling portion for controlling an open state and a connection state of the first switch based on the measurement result of the battery voltage measuring portion.

According to an embodiment, there is provided a battery pack which includes one or a plurality of secondary batteries connected to each other, a positive pole terminal and a negative pole terminal to which external equipment is connected, a first switch which is connected between the positive pole of the secondary battery and the positive pole terminal or between the negative pole of the secondary battery and the negative pole terminal, a first resistance portion connected in parallel to the first switch, a battery voltage measuring portion for measuring the voltage of the secondary battery, and a controlling portion for controlling an open state and a connection state of the first switch based on the measurement result of the battery voltage measuring portion, wherein in a case where the voltage of at least one of one or the plurality of the secondary batteries is equal to or more than a predetermined first charging upper limit battery voltage, the controlling portion switches the first switch to the open state, and flows the charging current, which is supplied from the external voltage supplying portion connected to the positive pole terminal and the negative pole terminal, to the secondary battery via the first resistance portion.

According to an embodiment, there is provided a method of charging which includes measuring voltage of one or a plurality of secondary batteries connected with each other; and switching a first switch installed in a current path of a charging current flowing in the secondary battery to an open state, in a case where the voltage of the secondary battery is equal to or more than a predetermined first charging upper limit battery voltage during charging, so as to flow the charging current via a first resistance portion connected parallel to the first switch.

As described above, in the embodiment of the invention, the voltages of one or the plurality of the secondary batteries connected with each other are measured, and a resistance value of a variable resistance portion is controlled based on the measurement result. Thus, it is possible to reduce the applied voltages to the secondary batteries during charging.

Furthermore, in the embodiment of the invention, the voltages of one or the plurality of the secondary batteries connected with each other are measured, in a case where the voltages of the secondary batteries are equal to or more than a predetermined first charging upper limit battery voltage during charging, the first switch, which is installed in the current path of the charging current flowing in the secondary batteries, is OFF, and the charging current is caused to flow via the first resistance portion connected in parallel to the first switch. Thus, it is possible to reduce the applied voltages to the secondary batteries during charging.

According to the embodiment of the invention, the variable resistance portion is installed in the current path to the secondary batteries, and the resistance value of the variable resistance portion is controlled based on the measurement results of the voltages of the secondary batteries. As a result, there is an effect in which the applied voltages to the secondary batteries are reduced during charging so that the charging can be executed so as not to exceed an over-charge detection voltage.

Furthermore, according to the embodiment of the invention, the first switch and the first resistance portion connected in parallel with each other are installed in the current path to the secondary batteries, when the voltage of the secondary battery is equal to or more than the first charging upper limit battery voltage during charging, the first switch is OFF, and the charging current is caused to flow via the first resistance portion. As a result, there is an effect in which the applied voltages to the secondary batteries are reduced during charging so that the charging can be executed so as not to exceed the over-charge detection voltage.

Additional features and advantages are described herein, and will be apparent from the following Detailed Description and the figures.

### BRIEF DESCRIPTION OF THE FIGURES

FIG. 1 is a block diagram showing a structure of one example of a battery pack according to a first embodiment;

FIG. 2 is a block diagram for illustrating how to control a switch.

FIG. 3 is a block diagram showing a structure of one example of a control IC.

FIG. 4 is a schematic diagram for illustrating a first judgment method.

FIG. 5 is a schematic diagram for illustrating a case where the first judgment method is applied at the time of inactivity.

FIG. 6 is a schematic diagram for illustrating a fourth judgment method.

FIG. 7 is a schematic diagram for illustrating a fifth judgment method.

FIG. 8 is a schematic diagram for illustrating a sixth judgment method.

FIG. 9 is a schematic diagram for illustrating a seventh judgment method.

FIG. 10 is a block diagram for illustrating how to control a cell balance.

FIGS. 11A and 11B are schematic diagrams for illustrating a structure of a resistance portion.

FIG. 12 is a schematic diagram for illustrating one example of a relationship of the temperature and the resistance value in the resistance portion.

FIG. 13 is a schematic diagram for illustrating one example of a relationship of the temperature and the resistance value in the resistance portion.

FIG. 14 is a flowchart for illustrating a flow of a charging controlling process of a battery pack according to the first embodiment.

FIG. 15 is a flowchart for illustrating a flow of a controlling process of a switch.

FIG. 16 is a flowchart for illustrating a flow of a controlling process of a switch.

FIG. 17 is a block diagram showing a structure of another example of the battery pack according to the first embodiment of the invention.

FIG. 18 is a block diagram showing a structure of another example of the battery pack according to the first embodiment of the invention.

FIG. 19 is a block diagram showing a structure of one example of a battery pack according to a second embodiment of the invention.

FIG. 20 is a block diagram showing a structure of one example of a battery pack according to a third embodiment of the invention.

FIG. 21 is a schematic diagram showing a structure of one example of a case where a temperature sensor is installed on a circuit substrate.

FIG. 22 is a schematic diagram showing a structure of one example of a case where a temperature sensor is installed in the vicinity of a battery.

FIG. 23 is a block diagram for illustrating how to control a switch in a case where a temperature sensor is installed in the vicinity of a resistance portion.

FIG. 24 is a block diagram for illustrating how to control a switch in a case where a temperature sensor is installed in the vicinity of a battery.

FIG. 25 is a schematic diagram showing one example of a first charging upper limit battery voltage.

FIGS. 26A and 26B are schematic diagrams showing one example of a second charging upper limit battery voltage.

FIG. 27 is a flowchart for illustrating a flow of a charging controlling process of a battery pack according to a third embodiment.

FIG. 28 is a flowchart for illustrating a flow of a controlling process of a switch.

FIG. 29 is a flowchart for illustrating a flow of a controlling process of a switch.

FIG. 30 is a block diagram showing another structure of the battery pack according to the third embodiment of the invention.

FIG. 31 is a block diagram showing a structure of one example of a battery pack according to a fourth embodiment of the invention.

FIG. 32 is a schematic diagram for illustrating a charging control example of a battery pack in a case where a variable resistance portion is used.

FIG. 33 is a block diagram showing a structure of one example of a battery pack with a fixed resistance portion installed therein.

FIG. 34 is a schematic diagram for illustrating a charging control example of a battery pack in a case where a fixed resistance portion is used.

FIG. 35 is a block diagram showing a structure of another example of the battery pack according to the fourth embodiment of the invention.

FIG. 36 is a block diagram showing a structure of one example of a battery pack according to a fifth embodiment of the invention.

FIG. 37 is a schematic diagram for illustrating a measurement result of the first embodiment.

FIG. 38 is a schematic diagram for illustrating a measurement result of the first embodiment.

FIG. 39 is a schematic diagram for illustrating a measurement result of the second embodiment.

FIG. 40 is a schematic diagram for illustrating the measurement result of the second embodiment.

FIG. 41 is a schematic diagram for illustrating a measurement result of a first comparison embodiment.

FIG. 42 is a schematic diagram for illustrating the measurement result of the first comparison embodiment.

FIG. 43 is a schematic diagram for illustrating a measurement result of a second comparison embodiment.

FIG. 44 is a schematic diagram for illustrating the measurement result of the second comparison embodiment.

FIG. 45 is a block diagram showing a structure of one example of a battery pack of related art.

### DETAILED DESCRIPTION

The present application will be described below with reference to the claims according to an embodiment. Furthermore, descriptions are made in the following order.

1. First Embodiment (an example where a switch and a resistance portion are installed in a current path)

2. Second Embodiment (an example where charging control FET is forcibly controlled)

3. Third Embodiment (an example where a temperature sensor is installed)

4. Fourth Embodiment (an example where a variable resistance portion is installed in a current path)

5. Fifth Embodiment (an embodiment where a switch and a resistance portion are installed between external electrode terminals)

Furthermore, embodiments described hereinafter are preferable concrete examples of the invention. While various technically preferable limitations are made thereto, in the following description, the scope of the invention is not limited to those embodiments unless there is description of the object of limiting the invention.

### 1. First Embodiment

A first embodiment of the invention will be described. In the first embodiment of the invention, a switch and a resistance portion connected in parallel with each other are installed in a path of a charging current to a secondary battery. In a case where voltage of the secondary battery exceeds a predetermined charging upper limit battery voltage, the switch is OFF so as to flow the charging current via the resistance portion. As a result, the charging voltage applied to the secondary battery is reduced, and charging is executed in a scope in which the voltage of the secondary battery does not exceed a predetermined voltage.

Structure of Battery Pack

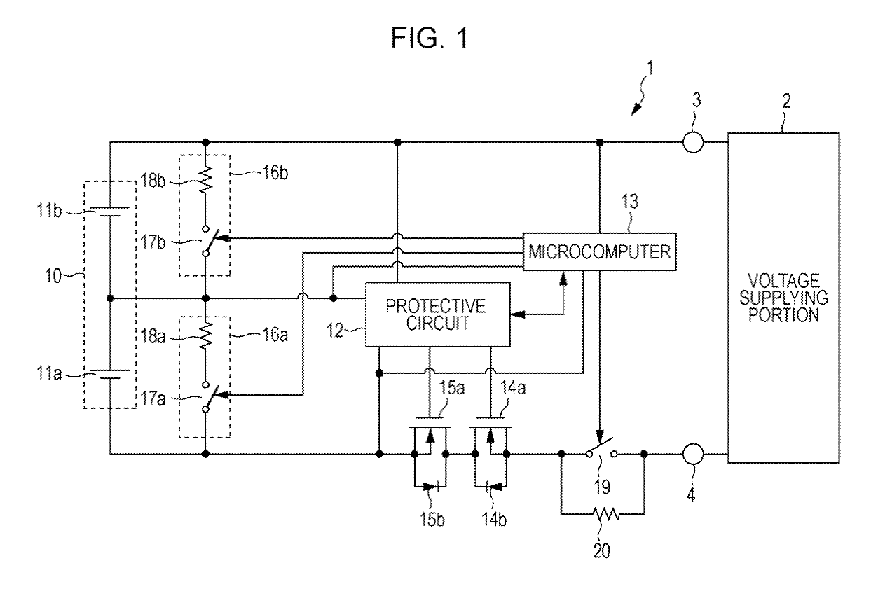

FIG. 1 shows a structure of one example of a battery pack 1 according to a first embodiment of the invention. The battery pack 1 has an assembled battery 10, a protective circuit 12 and a microcomputer 13. Furthermore, the battery pack 1 has a charging control FET 14a (Field Effect Transistor) and a discharging control FET 15a controlled by the protective circuit. Cell balance circuits 16a and 16b and a switch 19 are controlled by the microcomputer 13. A resistance portion 20 is connected in parallel with the switch 19. The switch 19 includes a FET and a relay or the like.

The assembled battery 10 includes batteries 11a and 11b connected in series with each other. As the batteries 11a and 11b, for example, lithium ion secondary batteries can be used. In the case of the lithium ion secondary battery, the battery pack is charged even by means of a CC-CV (Constant Current Constant Voltage) charging way in which a constant current charging is combined with a constant voltage charging. When the charging starts, the constant current charging to be charged with a constant current is performed, and when the battery voltage reaches a predetermined voltage, it is possible to switch from the constant current charging to the constant voltage charging by which the secondary battery is charged with the constant voltage. In addition, in the following description, if the batteries 11a and 11b do not have to be especially distinguished, they are simply referred to as “battery 11”.

The protective circuit 12 measures the voltage of the battery 11 (hereinafter, suitably referred to as “cell voltage”), detects the over-charge state or the over-discharge state from the measurement result, and controls the charging control FET 14a and the discharging control FET 15a by means of the detection result. When the cell voltage becomes the over charge detection voltage, the charging control FET 14a is OFF and the charging current is impeded. After the charging control FET 14a is OFF, only discharging is possible via a parasitic diode 14b. When the cell voltage becomes the over-charge detection voltage, the discharging control FET 15a is OFF and the discharging current is impeded. After the discharging control FET 15a is OFF, only charging via a parasitic diode 15b is possible. Furthermore, the protective circuit 12 supplies the measured cell voltage of the battery 11 for the microcomputer 13.

The switch 19 is controlled by the microcomputer 13. The switch 19 is inserted in the path of the charging current of the battery 11. At the time of discharging, the switch 19 is ON. When the cell voltage of the battery 11 exceeds the predetermined voltage, the microcomputer 13 switches the switch 19 from ON to OFF. When the switch 19 is OFF, the charging current flows in the resistance portion 20 connected in parallel with the switch 19, so that a voltage drop due to the resistance portion 20 occurs. With the voltage drop due to the resistance portion 20, the charging current for the battery 11 is reduced.

The cell balance circuit 16a includes a series connection of a switch 17a with a resistance portion 18a, and the series connection is connected in parallel to the battery 11a. The cell balance circuit 16b includes a series connection of a switch 17b with a resistance portion 18b, and the series connection is connected in parallel to the battery 11b. The microcomputer 13 judges whether or not the cell balance is collapsing. In a case where voltages of the batteries 11a and 11b do not coincide with each other, it is judged that the cell balance is collapsing.

If it is judged that the cell balance is collapsing, the cell balance circuits 16a and 16b connected in parallel to the batteries 11a and 11b are controlled, and among the batteries 11a and 11b, the battery 11 having a high cell voltage is discharged. For example, when the cell voltage of the battery 11a is higher than that of the battery 11b, the switch 17a is ON so that the battery 11a is discharged. On the contrary, when the cell voltage of the battery 11b is higher than that of the battery 11a, the switch 17b is ON so that the battery 11b is discharged. In addition, in the following description, in a case where the switches 17a and 17b and the resistance portions 18a and 18b do not have to be especially distinguished from each other, they are suitably referred to as “switch 17” and “resistance portion 18”, respectively.

Furthermore, while not shown, the microcomputer 13 includes a storing portion that stores various data such as the measured cell voltages and a communication terminal for communicating with connected main body equipment.

Charging Controlling Method

In the first embodiment, the switch 19 is controlled depending on the cell voltage of the battery 11, a maximum cell voltage at the time of the charging is controlled so as not to exceed a predetermined set voltage, for example 4.25 V (volts).

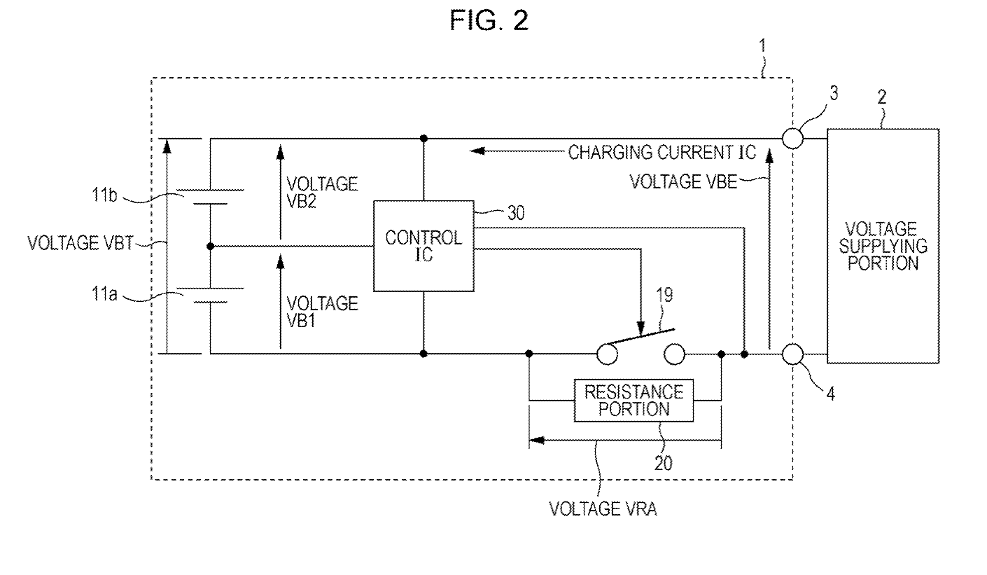

A method of controlling the switch 19 will be described. FIG. 2 is a diagram in which in order to facilitate the description regarding the method of controlling the switch 19, the portions other than the structure necessary for the description are omitted from the structure shown in FIG. 1. Namely, in the battery pack 1 shown in FIG. 2, the cell balance circuits 16a and 16b, and the charging control FET 14a and the discharging control FET 15a shown in FIG. 1 are omitted. A control IC 30 is an IC having functions of the protective circuit 12 and the microcomputer 13 shown in FIG. 1, measures the cell voltage of the battery 11 and controls the switch 19 based on the measurement result.

Herein, when a predetermined condition is established with respect to the cell voltage of the battery 11, the switch 19 is OFF by means of control of the control IC 30 so that a charging current IC flows via the resistance portion 20. The charging current flows in the resistance portion 20, which causes a voltage drop in the resistance portion 20, and the voltage applied to the battery 11 is reduced due to the voltage drop, so that the maximum cell voltage at the time of the charging can be suppressed below a set voltage (for example, 4.25 V). A value of the resistance portion 20 is set as follows.

{(maximum voltage applied to a single battery by a deviation)−4.25 V}/(charging finish current)

Herein, the charging finish current is the value of the charging current which has been set so as to detect the charging finish by a charger.

First Controlling Method of Switch 19

A first controlling method of the switch 19 will be described. In the first controlling method, a first charging upper limit battery voltage VBCA, which indicates an upper limit of the cell voltage of the battery 11 during charging, is set in advance. The control IC 30 compares cell voltages VB1 and VB2 of the batteries 11a and 11b with the first charging upper limit battery voltage VBCA. When at least one cell voltage is equal to or more than the first charging upper limit battery voltage VBCA, the switch 19 is OFF. Namely, if a condition indicated in the following formula (1) is established, the control IC 30 makes the switch 19 OFF.

VB1≧VBCA or VB2≧VBCA (1)

In a state in which the switch 19 is OFF, the charging current IC flows in the resistance portion 20, which causes a voltage drop VRA in the resistance portion 20. If it is assumed that a resistance value of the resistance portion 20 is RA, the voltage drop VRA that occurred in the resistance portion 20 is calculated by formula (2).

VRA=RA×IC (2)

Due to the voltage drop that occurred in the resistance portion 20, the maximum cell voltage in the battery 11 can be controlled so as to be equal to or less than the set voltage. For example, in the case where the set voltage is 4.25 V, the first charging upper limit battery voltage VBCA is set to be 4.19 V and the resistance value RA of the resistance portion 20 is set to be 0.8Ω (ohm), so that the maximum cell voltage in the battery 11 can be made lower than 4.25 V.

For example, in a case where the charging is performed with the voltage supplying portion 2 having the charging voltage of 4.24 V, if the switch 19 is OFF, the voltage drop in the resistance portion 20 becomes 40 mV. Namely, the charging voltage for the battery 11 becomes 4.2 V, which is calculated by subtracting 40 mV from the charging voltage 4.24 V of the voltage supplying portion 2. This is a rated charging voltage in the general lithium ion secondary battery. Thus, by controlling the charging in this manner, it is possible to charge the battery 11 with a suitable charging voltage.

The first charging upper limit battery voltage VBCA is set to be lower than the over-charge detection voltage. Thus, before the battery voltage is increased during charging so that the charging control FET 14a is OFF, the charging voltage is reduced, whereby it is possible to prevent the charging from being stopped. Furthermore, after the switch 19 is OFF, when cell voltages VB1 and VB2 of the batteries 11a and 11b are less than the first charging upper limit battery voltage VBCA, by turning the switch 190N, it is returned to charging state.

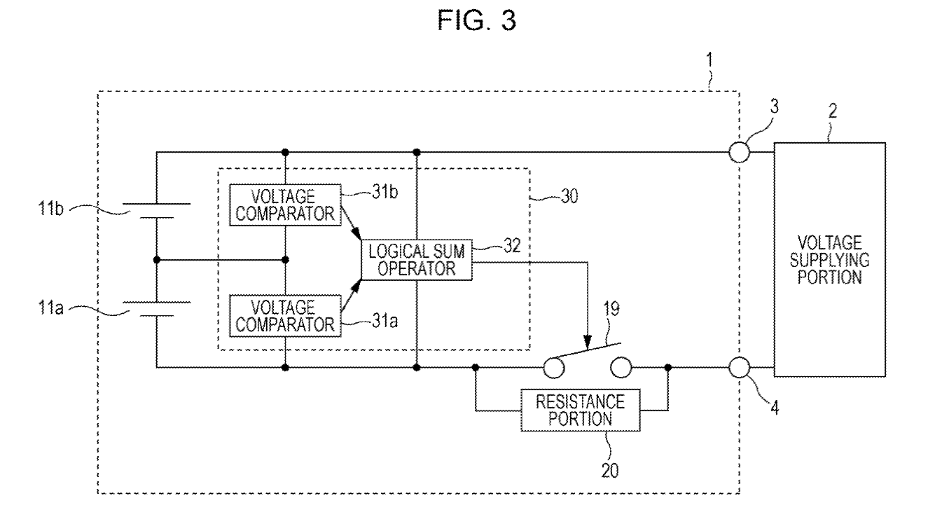

As shown in FIG. 3, the control IC 30 includes voltage comparators 31a and 31b and a logical sum operator 32. The voltage comparator 31a compares the cell voltage VB1 of the battery 11a with the first charging upper limit battery voltage VBCA, and outputs the value according to the comparison result to the logical sum operator 32. For example, in a case where the cell voltage VB1 is equal to or more than the first charging upper limit battery voltage VBCA, value “1” is output, and in a case where the cell voltage VB1 is less than the first charging upper limit battery voltage VBCA, value “0” is output.

Similar to the voltage comparator 31a, the voltage comparator 31b compare the cell voltage VB2 of the battery 11b with the first charging upper limit battery voltage VBCA and outputs the value according to the comparison result to the logical sum operator 32. For example, in a case where the cell voltage VB2 is equal to or more than the first charging upper limit battery voltage VBCA, the value “1” is output, and in a case where the cell voltage VB2 is less than the first charging upper limit battery voltage VBCA, the value “0” is output.

The logical sum operator 32 outputs the logical sum outputs of the values supplied from voltage comparators 31a and 31b as a control signal for controlling the switch 19. That is, the logical sum operator 32 operates the logical sum of the values supplied from the voltage comparators 31a and 31b, and in a case where at least any one value is “1”, outputs a controlling signal to make the switch 19 OFF.

Second Controlling Method of Switch 19

A second controlling method of the switch 19 will be described. In the second controlling method, in addition to the first controlling method described above, it is judged whether or not charging by the control IC 30 is taking place. The switch 19 can be OFF only during charging. That is, when the condition indicated in formula (3) is established, the control IC 30 makes the switch 19 OFF, and when the condition is not established, the control IC 30 turns the switch 19 ON.

“during charging” and (VB1≧VBCA or VB2≧VBCA) (3)

When the switch 19 is OFF, similar to the first controlling method described above, the voltage drop VRA based on the formula (2) occurs in the resistance portion 20, so it is possible to control the maximum cell voltage in the battery 11 so as to be equal to or less than the set voltage.

In the second controlling method, after the switch 19 is OFF, the OFF state is maintained until the charging is finished, and the switch 19 is ON at the time of finishing the charge. In this manner, it is judged whether or not charging is taking place, so that it is possible to avoid the electric power consumption due to the insertion of the resistance portion 20 at the time of the discharging.

Herein, a method for judging whether or not charging is taking place will be described. It is possible to judge whether or not charging is taking place by the use of any one of the first to seventh judgment methods described hereinafter.

First Judgment Method

The first judgment method will be described. In the first judgment method, a voltage VBT (hereinafter, suitably referred to as “battery voltage”) of an assembled battery 10 is measured for each predetermined sampling period. In addition, differential values DV of two continuous battery voltages VBT are calculated and the differential values DV are compared with predetermined set differential values SDV, so that it is judged whether or not charging is taking place.

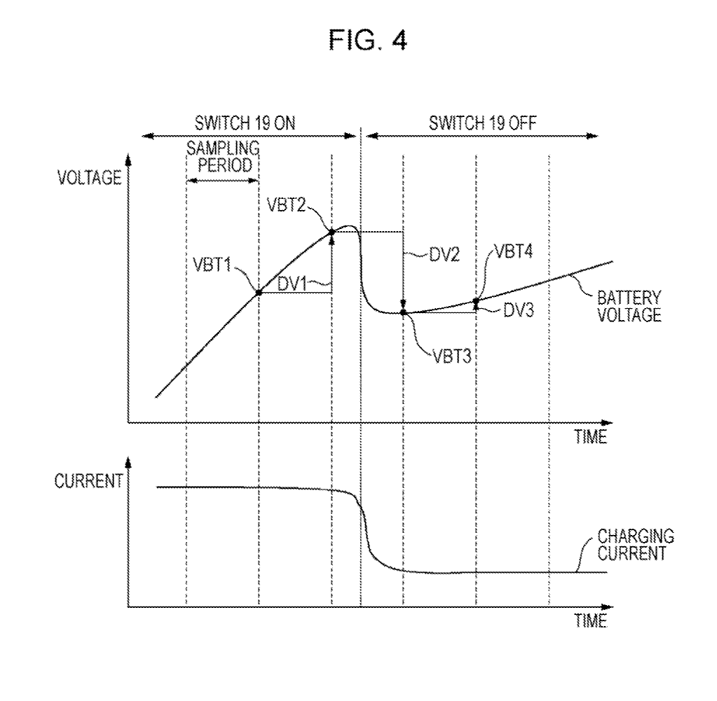

As shown in FIG. 4, the control IC 30 measures and stores battery voltages VBT1, VBT2, VBT3, and VBT4 for each sampling period. In addition, on the basis of the battery voltages VBT1 to VBT4, differential values DV1, DV2 and DV3 of the continuous battery voltages are calculated. The differential values DV1 to DV3 are calculated by the following formulas (4) to (6).

DV1=VBT2−VBT1 (4)

DV2=VBT3−VBT2 (5)

DV3=VBT4−VBT3 (6)

Thereafter, the control IC 30 compares the calculated differential values DV1 to DV3 with the predetermined set differential values SDV. Among the conditions indicated in the following formula (7), it is that the charging is taking place when more than two conditions are established, and otherwise it is judged not during charging.

DV1≧SDV, DV2≧SDV, DV3≧SDV (7)

As described above, it is possible to judge whether or not charging is taking place. For example, it is considered where the sampling periods are 10 seconds, the set differential values SD are 0.01 V and the battery voltages VBT1 to VBT4 measured for each sampling period are 8.00 V, 8.10 V, 7.95 V and 7.98 V, respectively.

For each case, the differential values DV1 to DV3 that are calculated on the basis of the formulas (4) to (6) are 0.1 V, −0.15 V and 0.03 V, respectively. Thus, the DV 1 to DV 3 are equal to or more than the set differential values SDV, so that the charging state is detected.

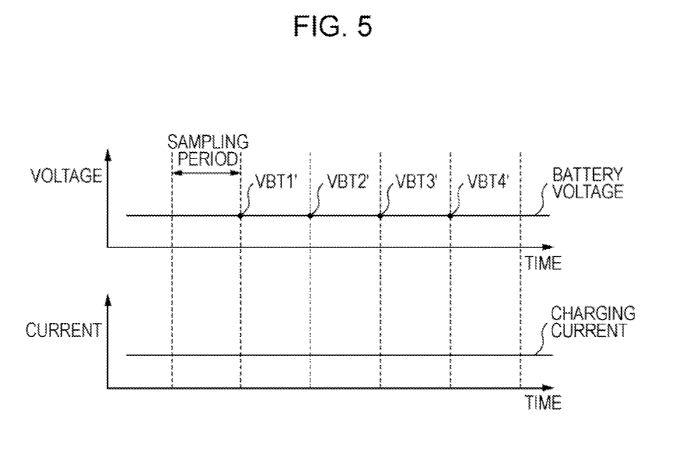

On the other hand, at the time of idling in which the charger and the main body equipment are not connected to the battery pack 1, as shown in FIG. 5, neither the charging current or the discharging current flow, so that the battery voltages VBT1′ to VBT4′ are not changed. As a result, the differential values DV1′ to DV3′ of the battery voltages VBT1′ to VBT4′ which are calculated on the basis of the formulas (4) to (6) described above become about 0 V, respectively. Thus, since the condition of the above-described formula (7) is not established, it is possible to judge that charging is not taking place.

In addition, it is preferable that the number of the measurements of the battery voltage be about four times. The case where the number of the measurements of the battery voltages is set to be two is considered. When the switch 19 is OFF between the initial voltage measurement and the next voltage measurement, the voltage drop in the resistance portion 20 causes the charging voltage and the charging current for the battery 11 to decline and the battery voltage VBT to decline. As a result, when the above-described judgments are performed, there occurs a problem that the differential value DV is less than the set differential value SDV and it is judged that charging is not taking place even though charging is taking place.

Second Judgment Method

A second judgment method will be described. In the second judgment method, it is judged whether or not charging is taking place by means of the voltages of both ends of the resistance portion 20. The control IC 30 measures the voltages of both ends of the resistance portion 20, and when the measured voltages are equal to or more than fixed values predetermined as voltage values in a charge direction, the control IC 30 judges that charging is taking place.

Third Judgment Method

A third judgment method will be described. In the third judgment method, based on the battery voltages VBT of the assembled battery 10 and the voltage VBE (hereinafter, suitably referred to as “terminal voltage”) between the positive pole terminal 3 and the negative pole terminal 4 connected to the voltage supplying portion 2, it is judged whether or not charging is taking place.

During charging, it is thought that the battery voltage VBT of the assembled battery 10 is lower than the charging voltage VBE supplied from the voltage supplying portion 2. Thus, by comparing the battery voltage VBT with the terminal voltage VBE, it is possible to judge whether or not charging is taking place.

The control IC 30 calculates the battery voltage VBT of the assembled battery 10 based on the cell voltage of the battery 11. In addition, the control IC 30 calculates the terminal voltage VBE based on the voltages of the positive pole terminal 3 and the negative pole terminal 4 of the battery pack 1. The battery voltage VBT is compared with the terminal voltage VBE, and when the condition indicated in the following formula (8) is established, it is judged that charging is taking place, and when the condition is not established, it is judged that charging is not taking place.

battery voltage VBT<terminal voltage VBE (8)

Fourth Judgment Method

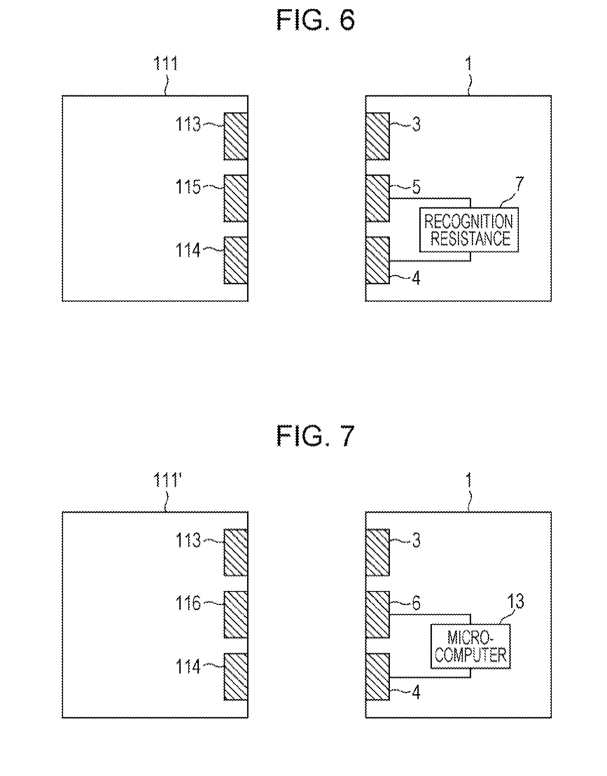

A fourth judgment method will be described. As shown in FIG. 6, in order to judge whether the battery pack to be charged is regular or not, a recognition terminal 5 is installed in the battery pack 1, and a recognition resistance 7 is connected between the recognition terminal 5 and the negative pole terminal 4. When the voltage supplying portion 2 is connected to the battery pack 1, a predetermined current flows with respect to the recognition resistance 7. Based on the current flowing in the recognition resistance 7 and the voltage drop that occurred in the recognition resistance 7, it is judged whether or not charging is taking place. For example, when the voltage drop occurs in the recognition resistance 7, it is judged that charging is taking place.

Fifth Judgment Method

A fifth judgment method will be described. As shown in FIG. 7, for example, a communication terminal 6 is installed in the battery pack 1 and is connected to the microcomputer 13. By means of the microcomputer 13, the battery pack 1 is caused to communicate with a microcomputer of the main body equipment 111′. Based on whether or not the communication with the main body equipment 111′ is executed by the use of the communication terminal 6 installed in the battery pack 1, it is judged whether or not charging is taking place. For example, in a case where the microcomputer 13 communicates with the main body equipment 111′ via the communication terminal 6, it is judged that discharging is taking place. On the other hand, in a case where the microcomputer 13 does not communicate with the main body equipment 111′, it is judged that charging is taking place.

Sixth Judgment Method

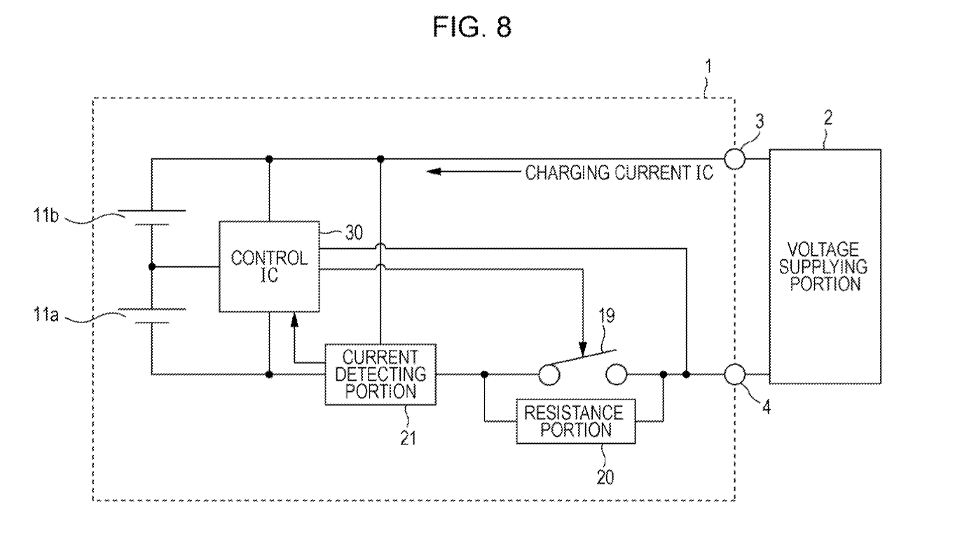

A sixth judgment method will be described. In the sixth judgment method, the charging current is measured and it is judged whether or not charging is taking place based on the measurement result. As shown in FIG. 8, a current detection portion 21 is installed in the current path. The current detection portion 21 measures the size and the direction of the current flowing in the current path, and provides the control IC 30 with the measurement results. The control IC 30 judges that charging is taking place when the current flows in the charge direction, based on the measurement results. On the other hand, when the current flows in the discharge direction or when the current does not flow, the control IC 30 judges that charging is not taking place.

The current detection portion 21, for example, may measure the current by the predetermined number of times for each predetermined sampling period, and calculate an average current value based on the current values of the predetermined numbers measured to use it in the judgment. In the sixth judgment method, since the charging current is directly measured, it is possible to judge more certainly whether charging is taking place, as compared with the judgment method based on the battery voltage.

Seventh Judgment Method

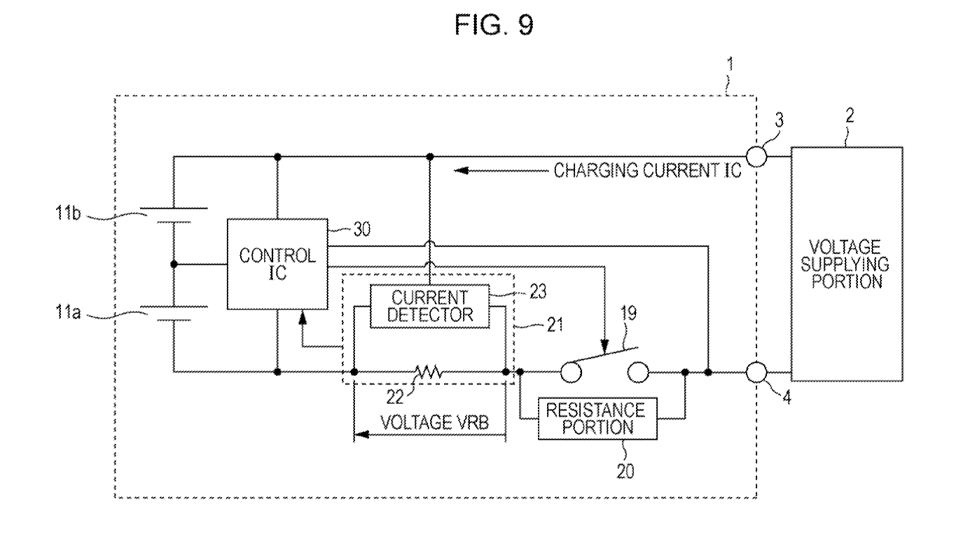

A seventh judgment method will be described. In the seventh judgment method, the voltage of the current detection resistance installed in the current path is measured, and based on the measurement result, it is judged whether or not charging is taking place. As shown in FIG. 9, the current detection portion 21 includes a current detection resistance 22 and a current detector 23. The current detector 23 measures the voltages VRB of both ends of the current detection resistance 22 and provides the control IC 30 with the measurement result.

The control IC 30 compares the provided voltage VRB with the predetermined charging judgment voltage, and when the voltage VRB is equal to or more than the charging judgment voltage, judges that charging is taking place. That is, when the condition indicated in the following formula (9) is established, the control IC 30 judges that charging is taking place, and when the condition indicated in the following formula (9) is not established, the control IC 30 judges that charging is not taking place.

voltage VRB≧charging judgment voltage (9)

The current detector 23 may measure the voltage of the current detection resistance 22 by the prescribed number of times for each predetermined sampling period, and based on the voltage values of the measured prescribed number of times, calculate the average voltage value and use the same in the judgment.

Controlling Method of Cell Balance

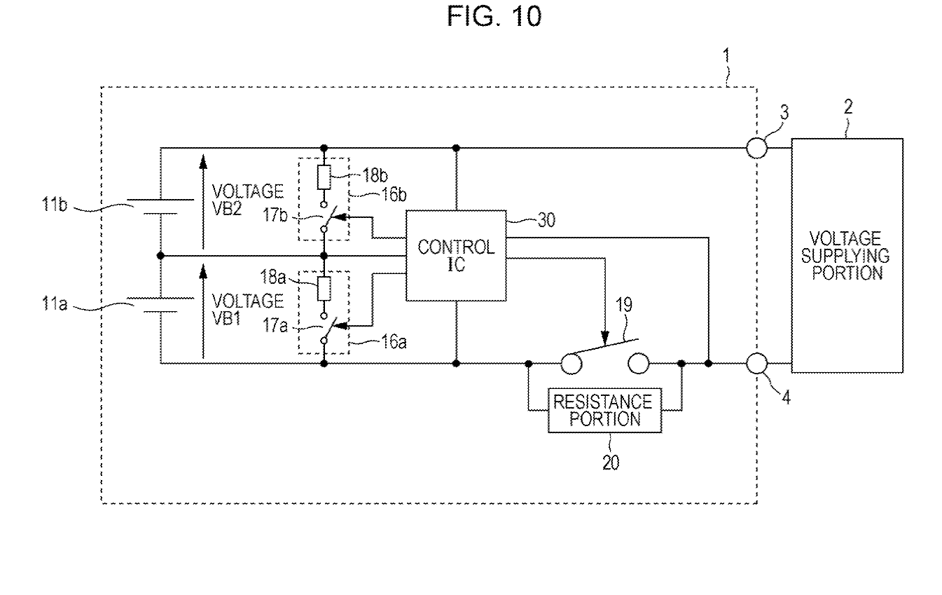

A controlling method of cell balance will be described with reference to FIG. 10. In the first embodiment, each battery voltage is controlled so that the cell voltages VB1 and VB2 of the batteries 11a and 11b are approximately equal to each other.

In addition, FIG. 10 shows only portion of the structure necessary for describing the controlling method of the cell balance. That is, in the battery pack 1 shown in FIG. 10, the charging control FET14a and the discharging control FET15a are omitted. The control IC 30 has the functions of the protective circuit 12 and the microcomputer 13.

The cell balance circuits 16a and 16b are each connected in parallel to the batteries 11a and 11b. In a state in which the switches 17a and 17b installed at the cell balance circuits 16a and 16b are OFF, the current does not flow in the cell balance circuits 16a and 16b. When the prescribed condition is established in relation to the cell voltages of the batteries 11a and 11b, the switches 17a and 17b are ON by means of the control IC 30.

When the switch 17a installed at the cell balance circuit 16a is ON, the discharging current of the battery 11a flows in the resistance portion 18a, thereby resulting in the cell voltage of the battery 11a being dropped. During charging, one portion of the charging current from the voltage supplying portion 2 flows to the resistance portion 18a, so that the increase in the voltage of the battery 11a is suppressed. Similarly, when the switch 17b installed at the cell balance circuit 16b is ON, the discharging current of the battery 11b flows to the resistance portion 18b, thereby resulting in the cell voltage of the battery 11b being dropped. During charging, one portion of the charging current from the voltage supplying portion 2 flows to the resistance portion 18b, so that the increase in the voltage of the battery 11b is suppressed.

As controlling methods of the switches 17a and 17b, first to third controlling methods described hereinafter can be used.

First Controlling Method of Switches 17a and 17b

A first controlling method sets in advance a second charging upper limit battery voltage VBCB and an upper limit battery voltage difference VBDL that are used for controlling the cell balance. When charging is taking place and the cell voltage VB1 of the battery 11a is equal to or more than the second charging upper limit battery voltage VBCB, the control IC 30 turns the switch 17a ON. Even when charging is taking place and the difference (VB1−VB2) of the cell voltages VB1 and VB2 of the batteries 11a and 11b is equal to or more than the upper limit battery voltage difference VBDL, the control IC 30 turns the switch 17a ON.

That is, when the condition indicated in the following formula (10) is established, the control IC 30 turns the switch 17a ON, and when the condition is not established, the control IC 30 turns the switch 17a OFF.

“during charging” and (VB1≧VBCB or VB1−VB2≧VBDL) (10)

Similar to the above, the control IC 30 controls the switch 17b. That is, when the condition indicated in the following formula (11) is established, the control IC 30 turns the switch 17b ON, and when the condition is not established, the control IC 30 turns the switch 17b OFF.

“during charging” and (VB2≧VBCB or VB2−VB1≧VBDL) (11)

Herein, the second charging upper limit battery voltage VBCB is prepared as a set value which is different from the first charging upper limit battery voltage VBCA described above. It is preferable that the second charging upper limit battery voltage VBCB be equal to the first charging upper limit battery voltage VBCA or be lower than the first charging upper limit battery voltage.

It is preferable that the second charging upper limit battery voltage VBCB be set to the value lower than the overcharge detection voltage. In this manner, before the overcharging is detected during charging to turn the charging control FET14a OFF, the cell voltage drops because of the discharging due to the cell balance circuits 16a and 16b so that the stopping of the charging can be prevented.

In the first controlling method of the switches 17a and 17b described above, it is configured so that the cell voltages VB1 and VB2 are measured and the switches 17a and 17b are controlled for each controlling period. After the switches 17a and 17b becomes ON based on the first controlling method, the discharging current flows in the resistance portions 18a and 18b, whereby the cell voltages VB1 and VB2 instantly drop.

At this time, after the switches 17a and 17b become ON, when the processing indicated in the first controlling method is performed after the controlling period times have passed, the conditions indicated in the formulas (10) and (11) are not established due to the drop in the cell voltage, so that the switches 17a and 17b are OFF again. In the case where the switches 17a and 17b are OFF again, since the cell voltage is not sufficiently dropped, the cell voltages VB1 and VB2 rise immediately, and after the next control period times have passed, the conditions indicated in the formulas (10) and (11) are established. That is, if the switches 17a and 17b are controlled for each control period time, ON/OFF movements of the switches 17a and 17b are repeated for each control period time.

Thus, in the first controlling method, a maintenance time during which the states of the switches 17a and 17b are maintained is previously set, and when the switches 17a and/or 17b are ON, it is preferable that the states of the switches 17a and 17b be maintained during the set maintenance time. Specifically, for example, when the control period time is set to be about 10 seconds, the maintenance time is about 60 seconds.

Second Controlling Method of Switches 17a and 17b

In a second method, when charging is taking place and the difference (VB1−VB2) of the cell voltages VB1 and VB2 of the batteries 11a and 11b is equal to or more than the upper limit battery voltage difference VBDL, the switch 17a is ON. That is, when the condition indicated in the following formula (12) is established, the control IC 30 turns the switch 17a ON, and when the condition is not established, the control IC 30 turns the switch 17a OFF.

“during charging” and VB1−VB2≧VBDL (12)

Similar to the above, when the condition indicated in the following formula (13) is established, the control IC 30 turns the switch 17b ON, and when the condition is not established, the control IC 30 turns the switch 17b OFF.

“during charging” and VB2−VB1≧VBDL (13)

In addition, similar to the first controlling method, the second controlling method controls the switches 17a and 17b for each control period time, and after the switches 17a and 17b are ON, maintains the ON state during the maintenance time.

Third Controlling Method of Switches 17a and 17b

In a third method, when charging is taking place and the cell voltage VB1 of the battery 11a is equal to or more than the second charging upper limit battery voltage VBCB, the switch 17a is ON. That is, when the condition indicated in the following formula (14) is established, the control IC 30 turns the switch 17a ON, and when the condition is not established, the control IC 30 turns the switch 17a OFF.

“during charging” and VB1≧VBCB (14)

Similar to the above, when charging is taking place and the cell voltage VB2 of the battery 11b is equal to or more than the second charging upper limit battery voltage VBCB, the switch 17b is ON. That is, when the condition indicated in the following formula (15) is established, the control IC 30 turns the switch 17b ON, and when the condition is not established, the control IC 30 turns the switch 17b OFF.

“during charging” and VB2≧VBCB (15)

Similar to the first and second controlling methods, the switches 17a and 17b for each control period time are controlled, and after the switches 17a and 17b are ON, the ON state is maintained during the maintenance time.

Examples of Structures of Resistance Portions 20 and 18

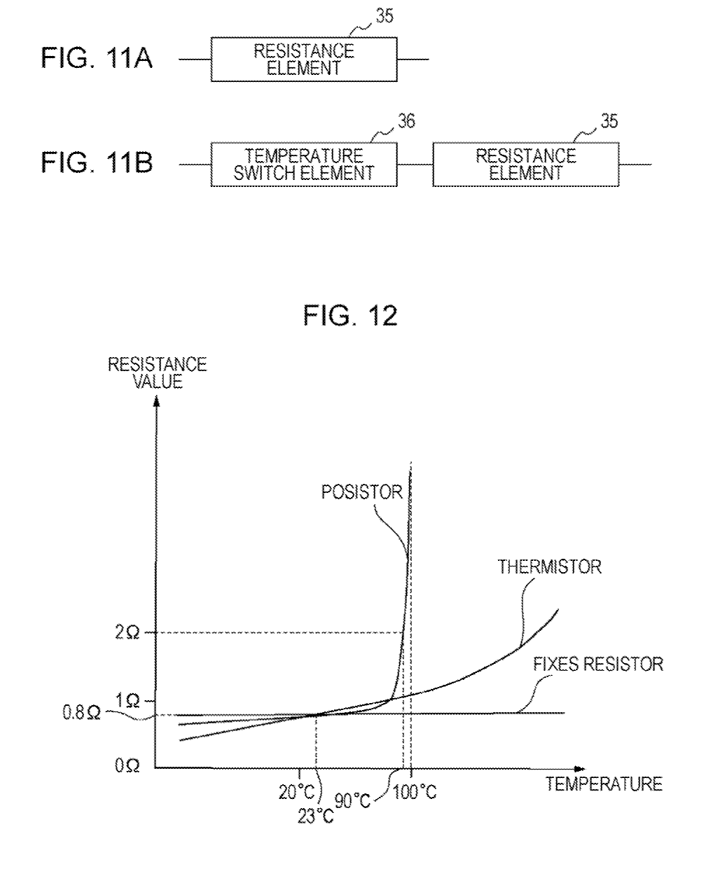

Elements that are applicable as the resistance portions 20 and 18 will be described. FIG. 11A shows a case where the resistance portions 20 and 18 include one resistance element 35. As the resistance element 35, a fixed resistor and a positive property thermistor, a positor, a PTC (Positive Temperature Coefficient), a fuse resistor and the like can be used. The fixed resistor is an element in which a difference in the resistance values due to the temperature is small. The positive property thermistor is an element in which the resistance value is increased according to an increase in the temperature. The positive property thermistor is classified into the posistor and the PTC based on the resistance value.

The posistor is a kind of positive property thermistor, and is an element in which the resistance value is large as compared with the PTC described later and has the typical value of about 10Ω or more. In the posistor, generally, the resistance values are rapidly increased in the prescribed temperature region. When the posistor is used as the resistance element 35, the over-voltage is applied to the resistance element 35, and when the over-current flows so that the temperature is increased, the resistance value is rapidly increased, thereby the flowing current is reduced.

The PTC is a kind of positive property thermistor, and is an element in which the resistance value is small as compared with the posistor and has the typical value of about 1Ω or less. Similar to the posistor, in the PTC, generally, the resistance value in the prescribed temperature region is rapidly increased. When the PTC is used as the resistance element 35, for example, the over-voltage is applied to the resistance element 35, and when the over-current flows so that the temperature is increased, the resistance value is rapidly increased, thereby resulting in the flowing current being decreased.

The fuse resistor is configured so that when the over-voltage is applied thereto and the over-current flows, so the temperature is increased, the current path of the element can be melted and cut so as to shut off the current.

As the resistance portion 20, for example, as shown in FIG. 11B, the resistance element 35, which is connected in series to the temperature switch element 36, can be used. As the temperature switch element 36, a thermostat and a temperature fuse can be used, for example.

The thermostat turns the switch OFF to the current when the temperature of the element is higher than that of the predetermined temperature. In addition, when the temperature of the element is lower than that of the set temperature, the thermostat turns the switch ON. In general, it is set so that the set temperature (shut off temperature) when the switch is OFF is different from the set temperature (return temperature) when the switch is ON, the shut off temperature is higher than the return temperature and the temperature difference thereof is about 1° C. to 20° C.

In a case where the temperature of the element becomes a high temperature, the temperature fuse melts and cuts the element of the fuse, thereby blocking the flowing current. When the fuse element is shut off, it is difficult to flow the current again. As the fuse element used for the temperature fuse, in general, low melting-point metals with the melting-points of about 100° C. to 200° C. are used.

FIG. 12 shows one example of the relationship of the temperature and the resistance value in the resistance portion 20. As the resistance element 35 used for the resistance portion 20, normally, the resistance elements 35 having the resistance values of about 10 mΩ to 90Ω are used, and more suitably, the resistance elements having the resistance values of about 100 mΩ to 5Ω are used. In this example, there is shown a property of a case where, as the resistance element 35 used for the resistance portion 20, the fixed resistor, the thermistor, and the posistor in which when the ambient temperature is 23° C., the resistance values thereof are about 0.8Ω are used.

As shown in FIG. 12, in the fixed resistor, the change in the resistance values due to the temperature is small and the resistance value thereof is about 0.8Ω. The resistance value of the thermistor is increased according to a rise in the temperature. The resistance value of posistor is increased according to a rise in the temperature, however, in particular, when the temperature becomes about 100° C., the resistance value thereof is rapidly increased.

Herein, for example, the consideration is given to the case where there is charged the battery pack 1 in which two batteries 11 having the charging upper limit voltages of 4.25 V are connected in series with each other and which uses the resistance portion 20 that includes the fixed resistor having the resistance value of 90 mΩ. In a case where, with respect to the battery pack 1, the voltage supplying portion 2 having the charging voltage of 8.4 V and the charging current value of 100 mA is connected to perform the charging, the voltage of the resistance portion 20 becomes 9 mV.

At this time, for example, assuming that the cell voltage of one battery 11 is 4.10 V, the cell voltage of the other battery 11 is 4.291 V and exceeds 4.25 V which is the charging upper limit voltage.

In this manner, when the resistance value of the resistance portion 20 is small, the voltage drop due to the resistance portion 20 is small so that it is difficult to sufficiently lower the cell voltage of the battery 11.

For example, the consideration is given to the case where the battery pack 1, which uses the resistance portion 20 formed of the fixed resistor having the resistance value of 100Ω and the switch 19 having the resistance value of 0.02Ω, is charged. In this case, assuming that the voltage of the resistance portion 20 is 0.02 V when the switch 19 is OFF, the current flowing in the resistance portion 20 becomes 0.2 mA. On the other hand, assuming that the voltage of the switch 19 is 0.02 V when the switch 19 is ON, the current flowing in the switch 19 becomes 1A.

Thus, in the case where the switch 19 is OFF, the flowing current is reduced as compared to the case where the switch 19 is ON, so the charging time is lengthened by more than about twice.

For example, the consideration is given to the case where the posistor is used as the resistance portion 20. When the posister is used as the resistance portion 20, as shown in FIG. 12, the resistance value is about 0.8Ω when the temperature is 23° C. Assuming that when the switch 19 is OFF, the voltage of the resistance portion 20 is 0.1 V, the current flowing in the resistance portion 20 becomes about 125 mA.

Furthermore, when the temperature becomes 90° C. due to the current flowing in the resistance portion 20, the resistance value of the resistance portion 20 becomes about 2Ω. As a result, the current flowing in the resistance portion 18 is reduced to about 50 mA.

In this manner, when the posistor is used as the resistance portion 20, the resistance value is increased at the time of the high temperature, so that it is possible to suppress the current amount flowing in the resistance portion 20 and prevent an increase in the temperature.

A resistance element 35 used for the resistance portion 20 may be determined depending to the use conditions of the battery pack 1 and the properties of the battery 11. For example, it is preferable that considering the battery capacity of the battery 11, the maximum charging current value, and the charging current value of the charge finishing condition, the resistance element 35 used for the resistance portion 20 be determined.

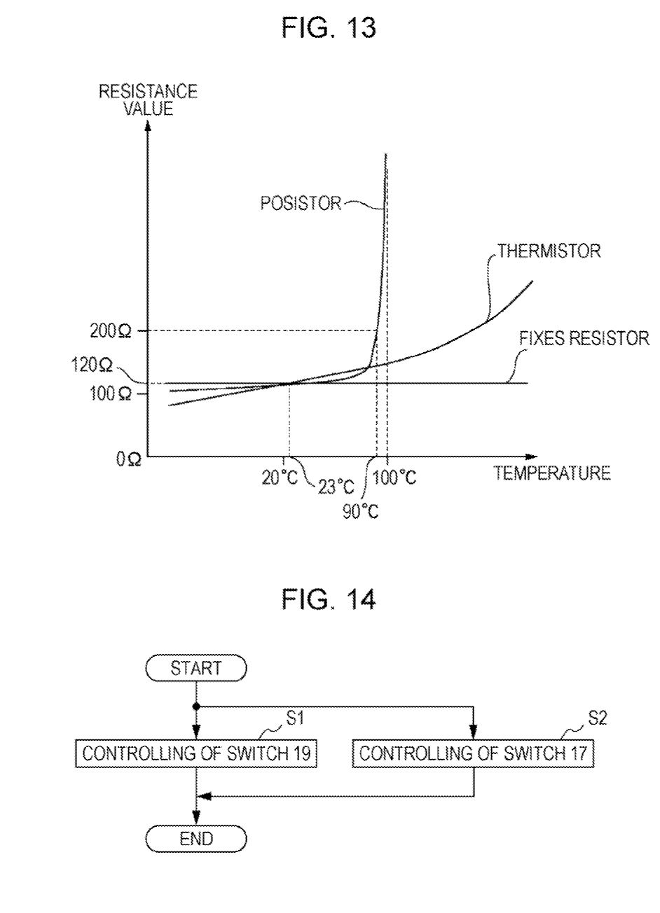

FIG. 13 shows one example of the relationship of the temperature and the resistance value in the resistance portion 18. As the resistance element 35 used for the resistant portion 18, the resistance elements usually having the resistance values of 1Ω to 9 kΩ, and more suitably, the resistance values of 10Ω to 1 kΩa are used. This example shows the property of the case where, as the resistance element 35 used for the resistance portion 18, the fixed resistor, the thermistor, and the posistor in which the resistance values are about 120Ω when the ambient temperature is 23° C. are used.

As shown FIG. 13, the fixed resistor represents a small change in the resistance values due to the temperature and has the resistance value of about 120Ω. The resistance value of the thermistor is increased according to a rise in temperature. The resistance value of the posistor is increased according to a rise in temperature, however, especially when the temperature is about 100° C., the resistance value thereof is rapidly increased.

Herein, for example, the consideration is giver for the case where the battery pack 1 is charged that uses the battery 11 in which the rated discharge capacity is 1500 mAh and the battery voltage is 4.25 V and the resistance portion 18 that includes the fixed resistor having the resistance value of 10 kΩ. In this case, when the switch 17 is ON, the current flowing in the resistance portion 18 becomes 0.425 mA, therefore when this state continues for one hour, the discharging current capacity due to the resistance portion 18 become 0.425 mAh. The discharging current capacity due to the resistance portion 18 is about 0.03% with respect to the rated discharge capacity of the battery 11, so that it is difficult to sufficiently regulate the cell voltage.

The heating value due to the resistance portion 18 is about 1.8 mW for each case and the heating value can be reduced. As a result, an amount of the temperature rise due to the heating value of the resistance portion 18 can be reduced.

As described above, when the resistance value of the resistance portion 18 is large, the amount of the temperature rise can be made small, but it is difficult to sufficiently regulate the cell voltage.

For example, the consideration is given to the case where the battery pack 1 is charged that uses the battery 11 in which the rated discharge capacity is 1500 mAh and the battery voltage is 4.25 V and the resistance portion 18 that includes the fixed resistor having the resistance value of 9Ω. In this case, when the switch 17 is ON, the current flowing in the resistance portion 18 becomes about 472 mA, therefore when this state continues for one hour, the discharging current capacity due to the resistance portion 18 become 472 mAh. The discharging current capacity of the battery 11 due to the resistance portion 18 is about 31% with respect to the rated discharge capacity of the battery 11, so that it is possible to sufficiently regulate the cell voltage.

On the other hand, the heating value due to the resistance portion 18 is about 2 W in this case, so the heating value is increased. As a result, the amount of the temperature rise due to the heating of the resistance portion 18 is increased.

As described above, when the resistance value of the resistance portion 18 is small, the cell voltage can be sufficiently adjusted, but the amount of the temperature rise is increased.

Thus, when the amount of the temperature rise is suppressed, as the resistance portion 18, for example, the posistor is used. When the posistor is used as the resistance portion 18, as shown in FIG. 13, the resistance value is about 120Ω when the temperature is 23° C. When the switch 17 is ON and, for example, the voltage of 4.2 V is applied to the resistance portion 18, the current flowing in the resistance portion 18 becomes about 35 mA, and the heating value due to the resistance portion 18 becomes about 147 mW.

In addition, when the temperature becomes 90° C. by the current flowing in the resistance portion 18, the resistance value of the resistance portion 18 becomes 200Ω. As a result, the current flowing in the resistance portion 18 is reduced to about 21 mA and the heating value due to the resistance portion 18 becomes about 88.2 mW.

In this manner, when the posistor is used as the resistance portion 18, because the resistance value at the time of the high temperature is increased, it is possible to suppress the increase in the heating value due to the rise in temperature and prevent the rise in temperature.

The resistance element 35 used for the resistance portion 18 may be determined according to the using conditions of the battery pack 1 and the properties of the battery 11. For example, it is preferable that, considering the battery capacity of the battery 11, the maximum charging current value, and the charge finishing condition, the resistance element 35 used for the resistance portion 20 be determined. Furthermore, when the rated discharge capacity of the battery 11 is large, the resistance value of the resistance portion 18 may be set to be small value, and when the rated discharge capacity of the battery 11 is large, the resistance value of the resistance portion 18 may be set to be the large value.

Charging Controlling Process

Hereinafter, the flow of the charging controlling process of the battery pack 1 according to the first embodiment of the invention will be described with reference to the flow charts shown in FIGS. 14 to 16. In addition, unless especially described, it is assumed that the following processes are performed under the control of the microcomputer 13.

In the first embodiment of the invention, the switches 19 and 17 are controlled and the charging for the batteries 11a and 11b are controlled. As shown in FIG. 14, in the charging controlling process for the battery pack 1, the control (step S1) of the switch 19 and the control (step S2) of the switch 17 are performed at the same time. Hereinafter, the controlling processes of each switch performed at the steps S1 and S2 will be described for each step.

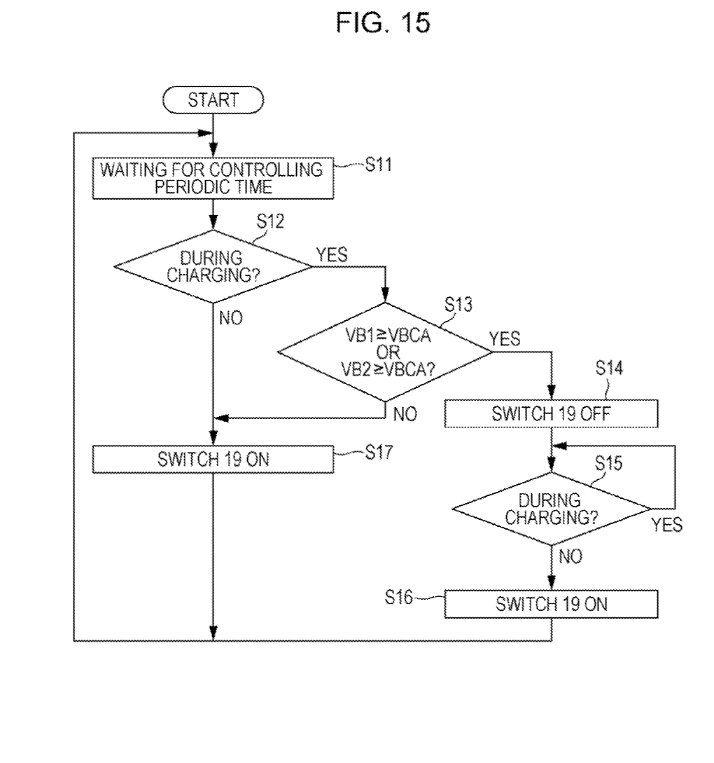

First of all, the flow of the controlling process of the switch 19 shown in the step S1 will be described with reference to FIG. 15. Herein, the second controlling method of the above-described switch 19 will be described. At a step S11, it is waited for the predetermined control period time, and at the point of time when the control period time is reached, a transition into the process after a step S12 is performed.

At the step S12, it is judged whether or not charging is taking place. The judgment of whether or not charging is taking place is performed by the use of any one of the above-described first to seventh judgment methods. When it is judged that charging is taking place, the process is transformed into a step S13. On the other hand, when it is judged that charging is not taking place, at a step S17, the switch 19 is ON.

At the step S13, the cell voltages VB1 and VB2 of the batteries 11a and 11b are compared with the first charging upper limit battery voltage VBCA. As a consequence of the comparison, when the cell voltage VB1 is equal to or more than the first charging upper limit battery voltage VBCA or when the cell voltage VB2 is equal to or more than the first charging upper limit battery voltage VBCA, at a step S14, the switch 19 is OFF.

At a next step S15, it is judged whether or not charging is taking place. When it is judged that charging is taking place, the process returns to the step S15, and it is judged whether or not charging is taking place again. When it is judged that charging is not taking place, at the step S16, the switch 19 is ON. In addition, the process returns to the step S11.

On the other hand, if the condition indicated at the step S13, at the step S17, the switch 19 is ON.

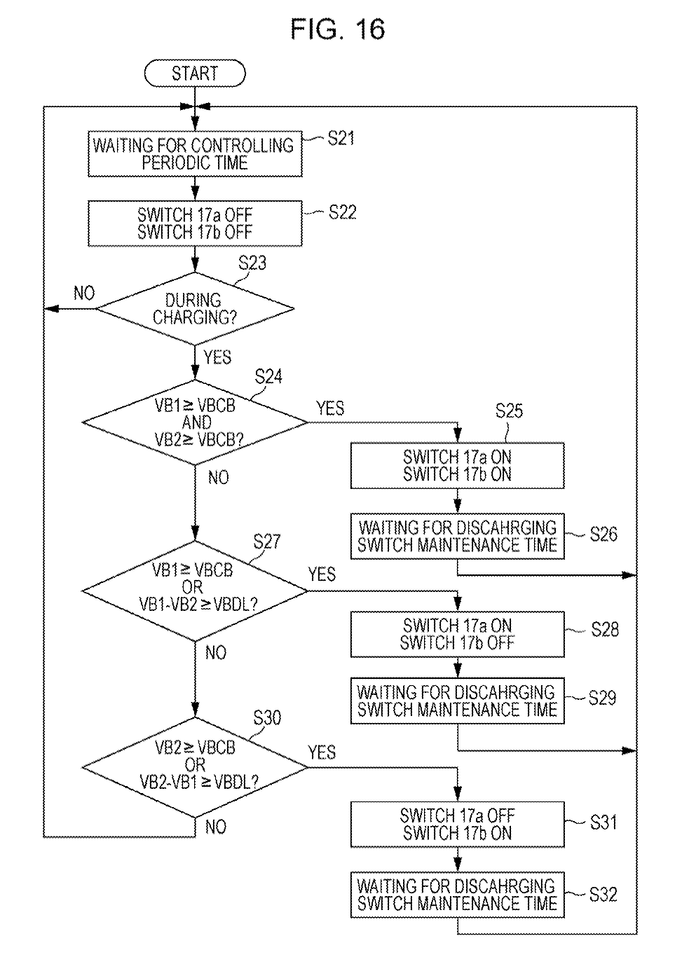

Next, the flow of the controlling process of the switch 17 shown in the step S2 will be described with reference to FIG. 16. Herein, the first controlling method of the above-described switches 17a and 17b is used. At a step S21, it is waited for the predetermined control period time, and at the point of time when the control period time is reached, a transition into the process after a step S22 is performed.

At a step S22, the switches 17a and 17b are OFF, and at a step S23, it is judged whether or not charging is taking place. The judgment of whether or not charging is taking place is performed by the use of any one of the above-described first to seventh judgment methods. When it is judged that charging is taking place, the process is transformed into a step S24. On the other hand, when it is judged that charging is not taking place, the process returns to the step S21, and it is waited for the control period time.

At the step S24, the cell voltages VB1 and VB2 of the batteries 11a and 11b are compared with the second charging upper limit battery voltage. As a consequence of the comparison, when the cell voltage VB1 is equal to or more than the second charging upper limit battery voltage VBCA, and when the cell voltage VB2 is equal to or more than the second charging upper limit battery voltage VBCB, the process is transformed into a step S25.

At the step S25, the switches 17a and 17b are ON, the discharge processes of the batteries 11a and 11b are performed by the cell balance circuits 16a and 16b. In addition, at a next step S26, the ON-states of the switches 17a and 17b are maintained for the predetermined maintenance time, and after the maintenance time has passed, the process returns to the step S21.

On the other hand, if the condition indicated at the step S24 is not established, the process is transformed into a step S27. At the step S27, the cell voltages VB1 of the battery 11a is compared with the second charging upper limit battery voltage VBCB. In addition, the difference (VB1−VB2) of the cell voltages VB1 and VB2 are compared with the upper limit battery voltage difference VBDL. As a consequence of the comparison, when the cell voltage VB1 is equal to or more than the second charging upper limit battery voltage VBCB, or when the difference (VB1−VB2) is equal to or more than the upper limit battery voltage difference VBDL, the cell balance is collapsed, and it is judged that the cell voltage VB1 is high. In addition, the process is transformed into a step S28.

At a step S28, the switch 17a is ON and the switch 17b is OFF, and the discharge process of the battery 11a is performed by means of the cell balance circuit 16a. In addition, at a next step S29, the ON-state of the switch 17a and the OFF-state of the switch 17b are maintained for the maintenance time, and after the maintenance time has passed, the process returns to the step S21.

On the other hand, if the condition indicated at the step S27 is not established, the process is transformed into a step S30. At the step S30, the cell voltage VB2 of the battery 11b is compared with the second charging upper limit battery voltage VBCB. In addition, the difference VB2−VB1 of the cell voltages VB2 and VB1 of the batteries 11b and 11a is compared with the upper limit battery voltage VBDL. As a consequence of the comparison, when the cell voltage VB2 is equal to or more than the second charging upper limit battery voltage VBCB, or when the difference (VB2−VB1) is equal to or more than the upper limit battery voltage difference VBDL, the cell balances of the batteries 11a and 11b are collapsed, and it is judged that the cell voltage VB2 is high. In addition, the process is transformed into a step S31.

At the step S31, the switch 17a is OFF and at the same time the switch 17b is ON, and the discharge process of the battery 11b is performed by means of the cell balance circuit 16b. At a next step S32, the OFF-state of the switch 17a and the ON-state of the switch 17b are maintained for the maintenance time, and after the maintenance time has passed, the process returns to the step S21.

On the other hand, if the condition indicated at the step S30 is not established, it is judged that the cell balances of the batteries 11a and 11b are not collapsed, and the process returns to the step S21.

In this manner, by controlling the switch 19 and the switches 17a and 17b, it is possible to charge so that the cell voltages VB1 and VB2 of the batteries 11a and 11b do not exceed the predetermined voltage such as the overcharge detection voltage.

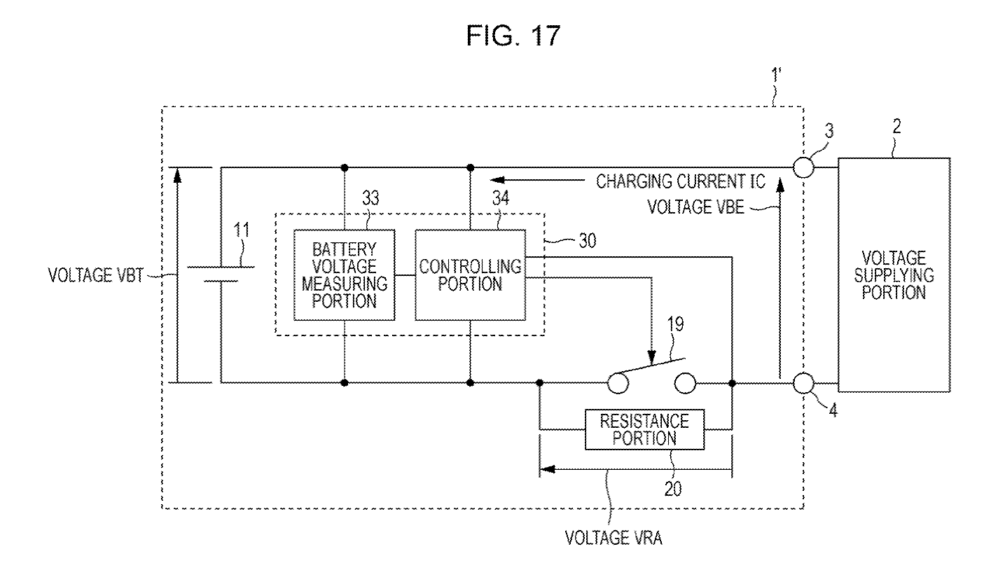

Furthermore, in the first embodiment of the invention, the battery pack 1 including a plurality of batteries 11a and 11b is described for example, but is not limited to this example. For example, as shown in FIG. 17, even with respect to the battery pack 1′ including one battery 11, it is possible to perform the charging control by applying the first and second controlling methods of the switch 19 described above.

In FIG. 17, the control IC 30 includes a battery voltage measuring portion 33 and a controlling portion 34. The switch 19 is controlled by the controlling portion 34 according to the first and second controlling methods of the switch 19 described above, based on the cell voltage VBT of the battery 11 measured by the battery voltage measuring portion 33.

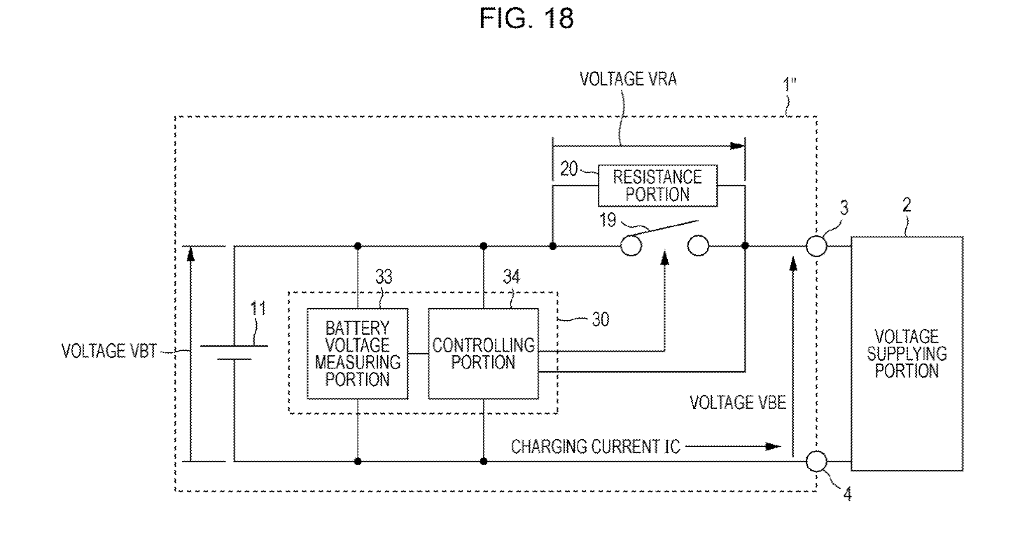

In addition, the switch 19 and the resistance portion 20, which are connected in parallel with each other, are not limited to a case where they are installed between a minus terminal of the battery 11 and the negative pole terminal 4, but they may be installed between a plus terminal of the battery 11 and the positive pole terminal 3, for example similar to a battery pack 1″ shown in FIG. 18.

### 2. Second Embodiment

A second embodiment will be described. In the second embodiment of the invention, the switch and the resistance, which are connected in series with each other, are connected in parallel between a drain terminal and a source terminal of the charging control FET, and at the same time, the other switch is connected between a gate terminal and the source terminal of the charging control FET. When the voltage of the secondary battery exceeds the predetermined charging upper limit battery voltage, the switches are controlled, and by flowing the charging current through the resistance, the charging voltage for the secondary battery is lowered, whereby the charging is performed so that the voltage of the secondary battery does not exceed the predetermined voltage.

Structure of Battery Pack

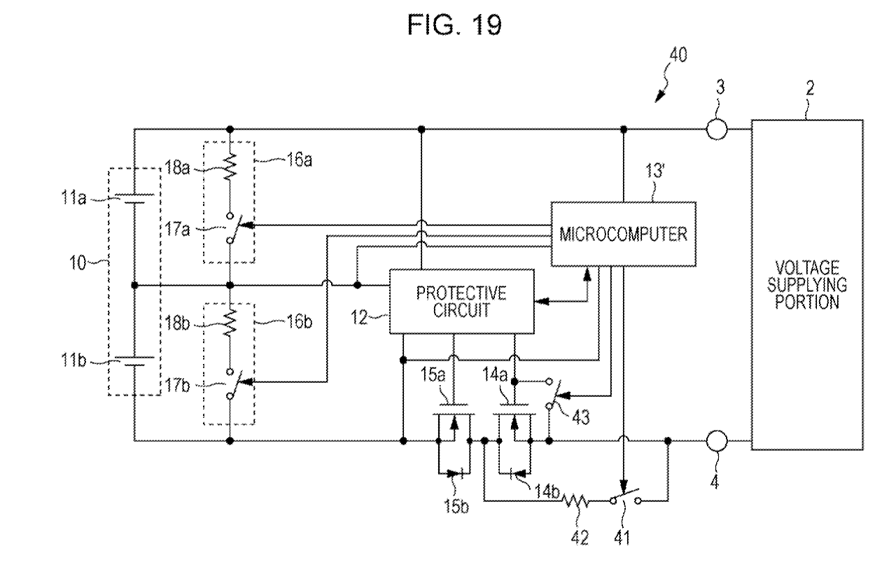

FIG. 19 shows a structure of a battery pack 40 according to the second embodiment of the invention. In addition, in FIG. 19, the portions common to FIG. 1 are denoted by the identical numbers, and the detailed descriptions thereof will be omitted. In the battery pack 40 according to the second embodiment, instead of the switch 19 and the resistance portion 20 in the first embodiment, a switch 41, a resistance portion 42 and a switch 43 are installed.

The switch 41 and the resistance portion 42 are connected in series with each other and are connected in parallel between the drain terminal and the source terminal of the charging control FET14a. By means of the control of the microcomputer 13′, the switch 41 is controlled so that it is OFF at the time of the usual operation and it is ON when the cell voltage of the battery 11 exceeds the first charging upper limit battery voltage.

The switch 43 is connected in parallel between the gate terminal and the source terminal of the charging control FET14a. By means of the control of the microcomputer 13′, the switch 43 is controlled so that it is OFF at the time of the usual operation and it is ON when the cell voltage of the battery 11 exceeds the first charging upper limit battery voltage.

Operation of Battery Pack

At the time of the usual operation, the switches 41 and 43 are OFF, so that the charging current flows through the charging control FET14a and the charging current does not flow in the resistance portion 42. During charging, when the cell voltage of the battery 11 exceeds the first charging upper limit battery voltage, the switch 41 is ON by means of the control of the microcomputer 13′, so that the charging current flows through the switch 41 and the resistance portion 42. The switch 41 is ON and at the same time the switch 43 is ON by means of the microcomputer 13′, so that the charging control FET14a is OFF.

In this manner, by controlling the switches 41 and 43, the charging current flows not through the charging control FET14a, but through the switch 41 and the resistance portion 42. The charging current flows in the resistance portion 42, whereby the voltage drop occurs in the resistance portion 42 and the voltage applied to the battery 11 is lowered due to the voltage drop, so that it is possible to suppress the maximum voltage at the time of the charging below the set voltage.

As described above, in the second embodiment of the invention, by controlling the switches 41 and 43, it is possible to charge so that the cell voltages of the batteries 11a and 11b do not exceed the predetermined voltage.

In the battery pack 1 according to the above-described first embodiment, because the first switch is installed in the current path, a loss occurs in the switch 19. On the other hand, in the battery pack 40, because the element which is a load such as the switch is not installed in the current path at the usual time, it is possible to perform the charging control similar to the first embodiment without lowering the output efficiency at the time of the usual operation.

### 3. Third Embodiment

The third embodiment of the invention will be described. The third embodiment of the invention is to install the temperature sensor, control the charging voltage based on the temperature, and at the same time prevent the damages of the elements and the deterioration of the secondary battery due to a high temperature.

Structure of Battery Pack

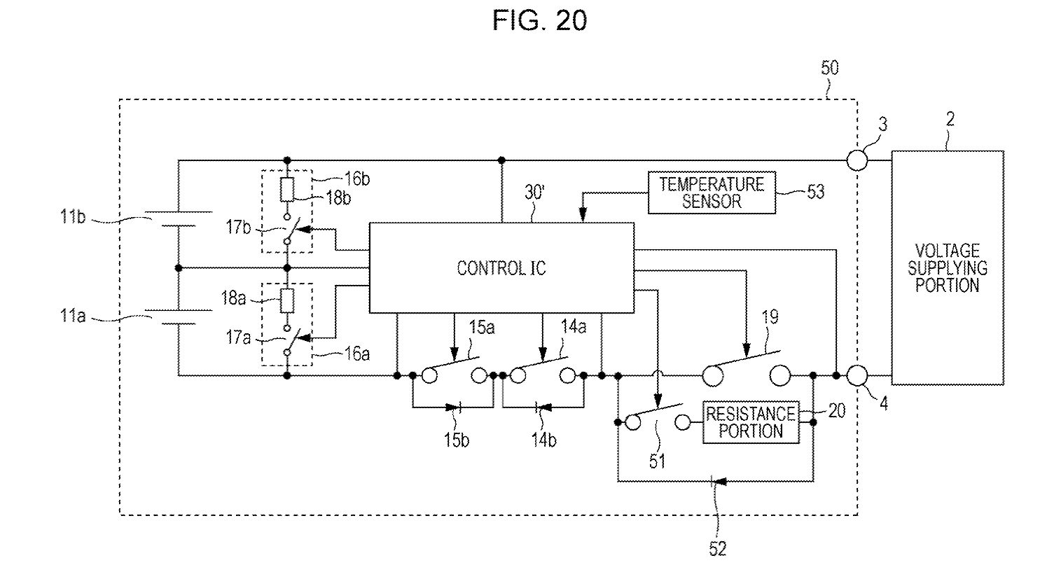

FIG. 20 shows a structure of a battery pack 50 according to a third embodiment of the invention. In addition, in FIG. 20, the portions common to FIG. 1 are denoted by the identical numbers and the detailed descriptions thereof will be omitted. In the battery pack 50, in addition to the battery pack 1 according to the first embodiment, a switch 51, a diode 52 and a temperature sensor 53 are further installed.

The switch 51 is connected in series with the resistance portion 20. The switch 51 is ON at the time of the usual operation, and the operation thereof is controlled on the basis of the control of the control IC 30′. The diode 52 is connected in parallel with the switch 19, and the resistance portion 20 and the switch 51 which are connected in series with each other. The diode 52 is connected so as to be able to flow the discharging current even when the switch 19 and the switch 51 are OFF.

The temperature sensor 53 is disposed on a substrate with electronic components mounted thereon or near the battery 11, and outputs temperature information based on the ambient temperature to the control IC 30′. As the temperature sensor 53, it is possible to use a positive property thermistor in which the resistance value is increased at the time of the high temperature, a negative property thermistor in which the resistance value is decreased at the time of the high temperature, and a metal resistor in which the resistance value is changed due to the temperature or the like.

The control IC 30′ is an IC that has the functions of the protective circuit 12 and the microcomputer 13 shown in FIG. 1. Similar to the above-described first embodiment, the control IC 30′ measures the cell voltage of the battery 11, detects the over-charge state and the over-discharge state based on the measurement result, and controls the charge FET14a and the discharge FET15a. The control IC 30′ judges whether or not the cell balance is collapsed based on the measured cell voltage and controls the cell balance circuits 16a and 16b so as to discharge the predetermined battery according to the judgment results.

In addition, the control IC 30′ controls the switch 19 and the switch 51 based on the temperature information supplied from the temperature sensor 53. For example, when the temperatures of the resistance portion 20 and the battery 11 reaches the predetermined temperature, the switch 19 and the switch 51 are OFF.

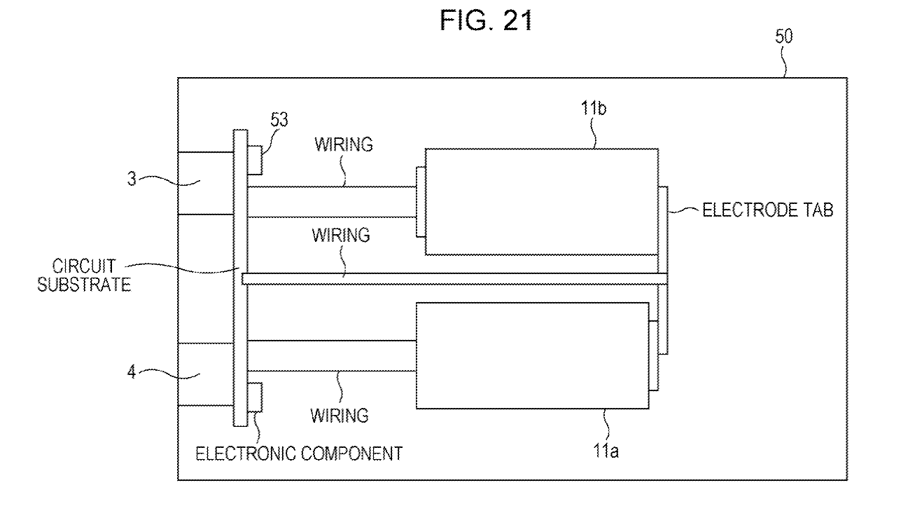

FIG. 21 shows a structure of one example of a case where the temperature sensor 53 is disposed on the circuit substrate. The batteries 11a and 11b and the circuit substrate are disposed within the housing of the battery pack 50. The plus terminal of the battery 11a and the minus terminal of the battery 11b are connected by an electrode tab, so that the batteries 11a and 11b are connected with each other. Furthermore, the minus terminal of the battery 11a is connected to the circuit substrate via the wiring and at the same time the plus terminal of the battery 11b is connected to the circuit terminal via the wiring.

The circuit substrate includes the positive pole terminal 3 and the negative pole terminal 4 and is installed so as to be exposed to the outside of the housing. On the circuit substrate, various electronic components such as the control IC 30′ and the resistance portion 20 are mounted. In this example, with respect to the circuit substrate, the temperature sensor 53 is further mounted.

The temperature sensor 53 mostly measures the temperatures of the electronic components which are mounted on the circuit substrate. For example, when the temperature sensor 53 is disposed in the vicinity of the resistance portion 20 on the substrate, it is possible to measure the heating due to the resistance portion 20. When the temperature sensor 53 is disposed at a position separated from the resistance portion 20, because the influence of the heating due to the resistance portion 20 is decreased and the difference between the temperature of the circuit substrate and the temperature of the battery 11 is within about 10° C., it is possible to indirectly measure the temperature of the battery 11.

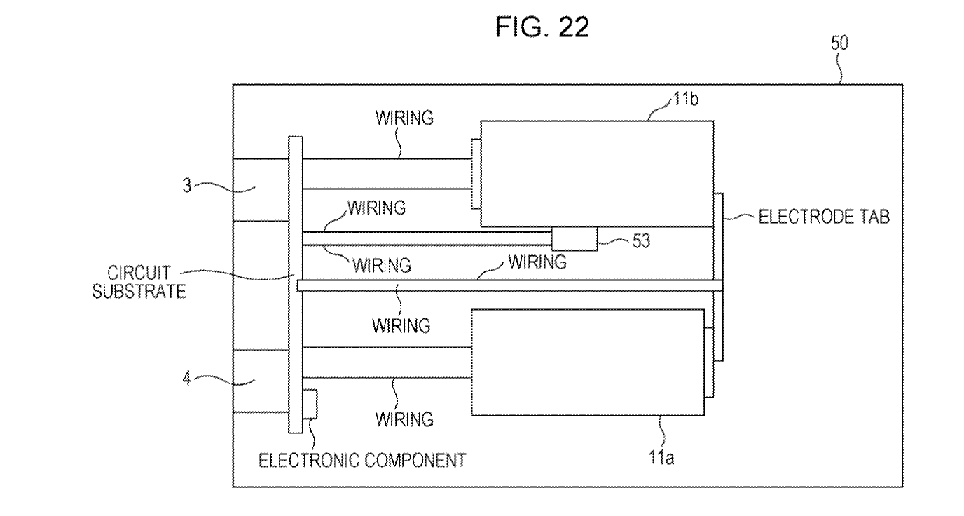

FIG. 22 shows a structure of one example of a case where the temperature sensor 53 is disposed in the vicinity of the battery 11. In the example shown in FIG. 22, the temperature sensor 53 is disposed in the vicinity of the battery 11 and is connected to the circuit substrate via the wiring. In this case, the temperature sensor 53 mostly measures the temperature of the battery 11 and can further precisely measure the temperature of the battery 11 as compared with the example shown in FIG. 21.

Charging Controlling Method

The charging controlling method of the battery pack 50 according to the third embodiment of the invention will be described. In the third embodiment, on the basis of the temperature information by the temperature sensor 53, the switch 19, the switch 17 and the third switch 51 are controlled, and the charging is performed so that the maximum cell voltage at the time of the charge does not exceed the predetermined set voltage. In addition, since the controlling method of the switch 17 is the same as the first embodiment, the description thereof will be omitted.

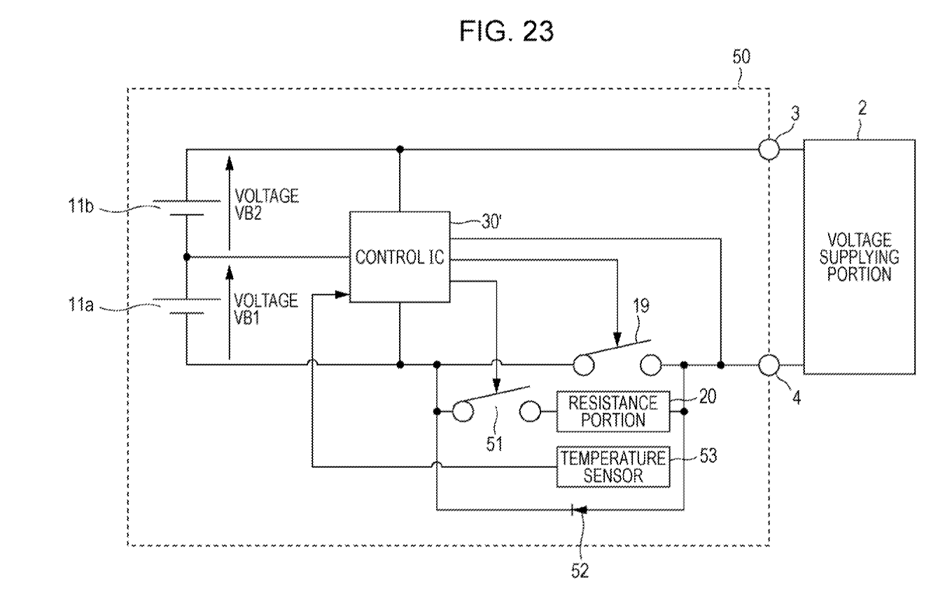

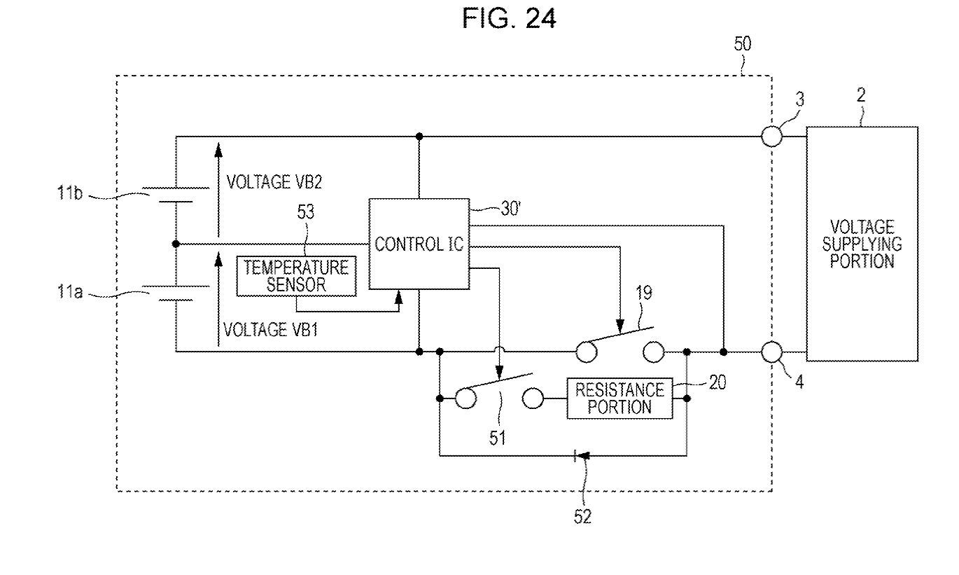

The controlling methods of the switch 19 and the switch 51 will be described with reference to FIGS. 23 and 24. In FIGS. 23 and 24, in order to facilitate the descriptions about the controlling methods of the switch 19 and the switch 51, the portions other than structure necessary for the description are omitted from the structure shown in FIG. 20. That is, there are omitted the cell balance circuits 16a and 16b, the charging control FET14a and the discharging control FET15a shown in FIG. 20. FIG. 23 shows an example in which the temperature sensor 53 is disposed in the vicinity of the resistance portion 20 and FIG. 24 shows an example in which the temperature sensor 53 is disposed in the vicinity of the battery 11.

As shown in FIGS. 23 and 24, in the battery pack 50 according to the third embodiment, the switch 19 and the resistance portion 20 and the switch 51, which are connected in series with each other, are connected in parallel with each other and are disposed in the current path for the battery 11. At the time of the normal operation, since the switch 19 and the switch 51 are ON and the current flows through the switch 19, the current does not flow in the resistance portion 20 and the switch 51.

If the predetermined condition is established with respect to the cell voltage of the battery 11 or the temperature of the temperature sensor 53, the switch 19 is OFF based on the control of the control IC 30′ so that the charging current IC flows through the resistance portion 20. The charging current flows in the resistance portion 20, which causes the voltage drop in the resistance portion 20, thereby resulting in the voltage applied to the battery 11 being lowered, so that the maximum cell voltage at the time of the charging can be suppressed below the set voltage.

When another condition is established with respect to the temperature of the temperature sensor 53, the switch 51 is OFF based on the control of the control IC 30′ and the charge for the battery 11 is prohibited. Thereby, in the example shown in FIG. 23, it is possible to prevent the damage of the resistance portion 20 due to the abnormal heating. In the example shown in FIG. 24, it is possible to prevent the deterioration of the battery 11 due to the abnormal heating.

With reference to FIG. 23, the controlling method of the switch 19 in a case where the temperature sensor 53 is disposed in the vicinity of the resistance portion 20 will be described. As the controlling method of the switch 19, first and second controlling methods described hereinafter can be used.

First Controlling Method of Switch 19

In the first controlling method of the switch 19, a resistance portion upper limit temperature RULC, which indicates an upper limit temperature of the resistance portion 20, is previously set. The control IC 30′ compares the temperature TA of the temperature sensor 53 with the resistance portion upper limit temperature RULC. In addition, the control IC 30′ compares the cell voltages VB1 and VB2 of the batteries 11a and 11b with the first charging upper limit battery voltage VBCA. As a consequence of the comparison, when the temperature TA is larger than the resistance portion upper limit temperature RULC, the switch 19 is OFF. Furthermore, when the cell voltage of at least any one of the cell voltages VB1 and VB2 is equal to or more than the first charging upper limit battery voltage VBCA, the switch 19 is OFF.

When the condition indicated in the following formula (16) is established, the control IC 30′ turns the switch 19 OFF, and when the condition is not established, the control IC 30′ turns the switch 19 OFF.

TA>RULC or VB1≧VBCA or VB2≧BCA (16)

In the first controlling method of the switch 19, after the switch 19 is OFF, the OFF-state is maintained until the charging is finished, and at the time of the finish of the charge, the switch 19 is ON.

Second Controlling Method of Switch 19

In a case where the temperature sensor 53 is disposed in the vicinity of the resistance portion 20, the second controlling method of the switch 19 will be described. In the second controlling method of the switch 19, the temperature TA of the temperature sensor 53 is compared with the resistance portion upper limit temperature RULC. In addition, the cell voltages VB1 and VB2 are compared with the first charging upper limit battery voltage VBCA. As a consequence of the comparison, when the temperature TA is larger than the resistance portion upper limit temperature RULC or when the cell voltages VB1 and VB2 are equal to or more than the first charging upper limit battery voltage VBCA, the switch 19 is OFF.

When the condition indicated in the following formula (17) is established, the control IC 30′ turns the witch 19 OFF, and when this condition is not established, the control IC 30′ turns the switch 190N.

TA>RULC or (VB1≧BCA and VB2≧BCA) (17)

Furthermore, in the second controlling method of the switch 19, after the switch 19 is OFF, the OFF-state is maintained until the charging is finished, and at the time of the finish of the charge, the switch 19 is ON.

First Controlling Method of Switch 51

The first controlling method of the switch 51 in a case where the temperature sensor 53 is disposed in the vicinity of the resistance portion 20 will be described. The first controlling method of the switch 51 compares the temperature TA of the temperature sensor 53 with the resistance portion upper limit temperature RULC. As a consequence of the comparison, when the temperature TA is larger than the resistance portion upper limit temperature RULC, the switch 51 is OFF.

When the condition indicated in the following formula (18) is established, the control IC 30′ turns the switch 51 OFF, and when this condition is not established, the control IC 30′ turns the switch 51 ON.

TA>RULC (18)

As described above, when the temperature of the resistance portion 20 becomes higher than the resistance portion upper limit temperature RULC, the switch 19 and the switch 51 are OFF to prohibit the charge, so that the damage of the resistance portion 20 due to the abnormal heating can be prevented. Herein, the resistance portion upper limit temperature RULC is, for example, set to be about 80° C.

Thereafter, as shown in FIG. 24, the controlling method of the switch 19 in a case where the temperature sensor 53 is disposed in the vicinity of the battery 11 will be described. As the controlling method of the switch 19, a third controlling method described hereinafter can be used.

Third Controlling Method of Switch 19

A third controlling method of the switch 19 in a case where the temperature sensor 53 is disposed in the vicinity of the battery 11 will be described. In the third controlling method of the switch 19, a charging upper limit temperature CULT indicating the upper limit temperature of the battery 11 and a charge lower limit temperature CLLT indicating the lower limit temperature thereof are previously set. The control IC 30′ compares the temperature TB of the temperature sensor 53 with the charging upper limit temperature CULT and the charge lower limit temperature CLLT. Furthermore, the control IC 30′ compares the cell voltages VB1 and VB2 with the first charging upper limit battery voltage VBCA. As a consequence of the comparison, in a case where charging is taking place and the temperature TB is higher than the charging upper limit temperature CULT or in a case where the temperature TB is lower than the charge lower limit temperature CLLT, the switch 19 is OFF. In addition, in a case where at least one cell voltage of the cell voltages VB1 and VB2 is equal to or more than the first charging upper limit battery voltage VBCA, the switch 19 is OFF.

When the condition indicated in the following formula (19) is established, the control IC 30′ turns the switch 19 OFF, and when this condition is not established, the control IC 30′ turns the switch 190N.

“during charging” and (TB>CULT or TB<CLLT or VB1≧BCA or VB2≧BCA) (19)

In addition, in the third controlling method of the switch 19, after the switch 19 is OFF, the OFF state is maintained until the charging is finished, and at the time of the finishing of the charge, the switch 19 is ON.

Furthermore, as a method of judging whether or not charging is taking place, the first to the seventh judgment methods in the above-described first embodiment can be used.

Second Controlling Method of Switch 51

A second controlling method of the switch 51 in a case where the temperature sensor 53 is disposed in the vicinity of the battery 11, will be described. The second controlling method of the switch 51 compares the temperature TB of the temperature sensor 53 with the charging upper limit temperature CULT and the charge lower limit temperature CLLT. As a consequence of the comparison, when the temperature TB is larger than the charging upper limit temperature CULT or when the temperature TB is smaller than the charge lower limit temperature CLLT, the switch 51 is OFF. When the condition indicated in the following formula (20) is established, the control IC 30′ turns the switch 51 OFF, and when this condition is not established, the control IC 30′ turns the switch 51 ON.

TB>CULT or TB<CLLT (20)

As described above, when the temperature of the battery 11 becomes higher than the charging upper limit temperature CULT and when the temperature of the battery 11 becomes lower than the charge lower limit temperature CLLT, the switch 19 and the switch 51 are OFF so as to prohibit the charge. As a result, it is possible to prevent the deterioration of the battery 11 due to the abnormal heating. The charging upper limit temperature CULT is, for example, set to be about 60° C. and the charge lower limit temperature CLLT is, for example, set to be about 0° C.

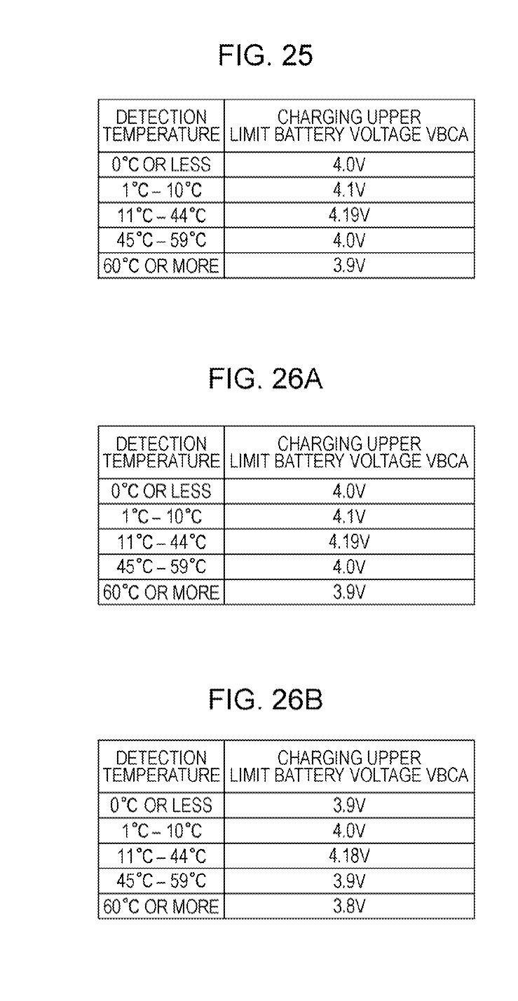

In addition, the first charging upper limit battery voltage VBCA, which is used at the time of controlling the switch 19, may be changed according to the temperature of the temperature sensor 53. For example, as shown in FIG. 25, the first charging upper limit battery voltage VBCA at the time of the room temperature (11° C. to 44° C.) is set to be 4.19 V. When the temperature of the temperature sensor 53 is equal to or less than 0° C., the first charging upper limit battery voltage VBCA is set to be 4.0 V. When the temperature of the temperature sensor 53 is between 1° C. and 10° C., the first charging upper limit battery voltage VBCA is set to be 4.1 V. When the temperature of the temperature sensor 53 is between 45° C. and 59° C., the first charging upper limit battery voltage VBCA is set to be 4.0 V. When the temperature of the temperature sensor 53 is equal to or more than 60° C., the first charging upper limit battery voltage VBCA is set to be 3.9 V.

Similar to the first charging upper limit battery voltage VBCA, the second charging upper limit battery voltage VBCB, which is used at the time of controlling the switch 17, may be also changed according to the temperature of the temperature sensor 53. For example, in a case where the second charging upper limit battery voltage VBCB is made to be the same as the first charging upper limit battery voltage VBCA, as shown in FIG. 26A, the second charging upper limit battery voltage VBCB at the time of the room temperature (11° C. to 44° C.) is set to be 4.19 V. When the temperature of the temperature sensor 53 is equal to or less than 0° C., the second charging upper limit battery voltage VBCB is set to be 4.0 V. When the temperature of the temperature sensor 53 is between 1° C. and 10° C., the second charging upper limit battery voltage VBCA is set to be 4.1 V. When the temperature of the temperature sensor 53 is between 45° C. and 59° C., the second charging upper limit battery voltage VBCB is set to be 4.0 V. When the temperature of the temperature sensor 53 is equal to or more than 60° C., the second charging upper limit battery voltage VBCB is set to be 3.9 V.

In addition, in a case where the second charging upper limit battery voltage VBCB is set to be lower than the first charging upper limit battery voltage VBCA, as shown in FIG. 26B, the second charging upper limit battery voltage VBCB at the time of the room temperature (11° C. to 44° C.) is set to be 4.18 V. When the temperature of the temperature sensor 53 is equal to or less than 0° C., the second charging upper limit battery voltage VBCB is set to be 3.9 V. When the temperature of the temperature sensor 53 is between 1° C. and 10° C., the second charging upper limit battery voltage VBCA is set to be 4.0 V. When the temperature of the temperature sensor 53 is between 45° C. and 59° C., the second charging upper limit battery voltage VBCB is set to be 3.9 V. When the temperature of the temperature sensor 53 is equal to or more than 60° C., the second charging upper limit battery voltage VBCB is set to be 3.8 V.

As described above, on the basis of the charging upper limit battery voltage at the time of the room temperature, the first charging upper limit battery voltage VBCA and the second charging upper limit battery voltage VBCB may be set so as to be lowered according to the high temperature or the low temperature.

Charging Controlling Process

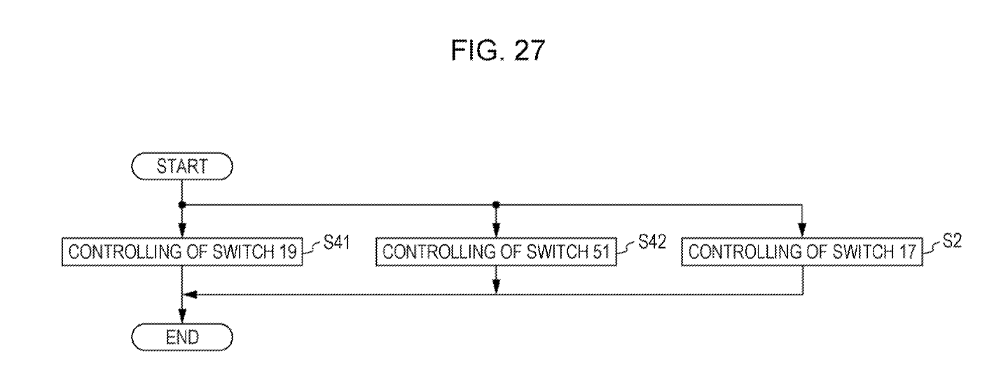

Next, the flow of the charging controlling process of the battery pack 50 according to the third embodiment of the invention will be described with reference to the flow charts shown in FIGS. 27 to 29. Furthermore, unless especially described, it is assumed that the following processes are performed under the control of the microcomputer 13.

In the third embodiment of the invention, the switch 19, the switch 17 and the switch 51 are controlled and the charges for the batteries 11a and 11b are controlled. As shown in FIG. 27, in the charging controlling process for the battery pack 50, the control of the switch 19 (step S41), the control of the switch 51 (step S42) and the control of the switch 17 (step S2) are simultaneously performed.

Hereinafter, controlling processes of each switch executed at the steps S41 and S42 are described for each step. In addition, since the controlling process of the switch 17 at the step S2 is the same as the process shown in FIG. 16, the description thereof will be omitted.

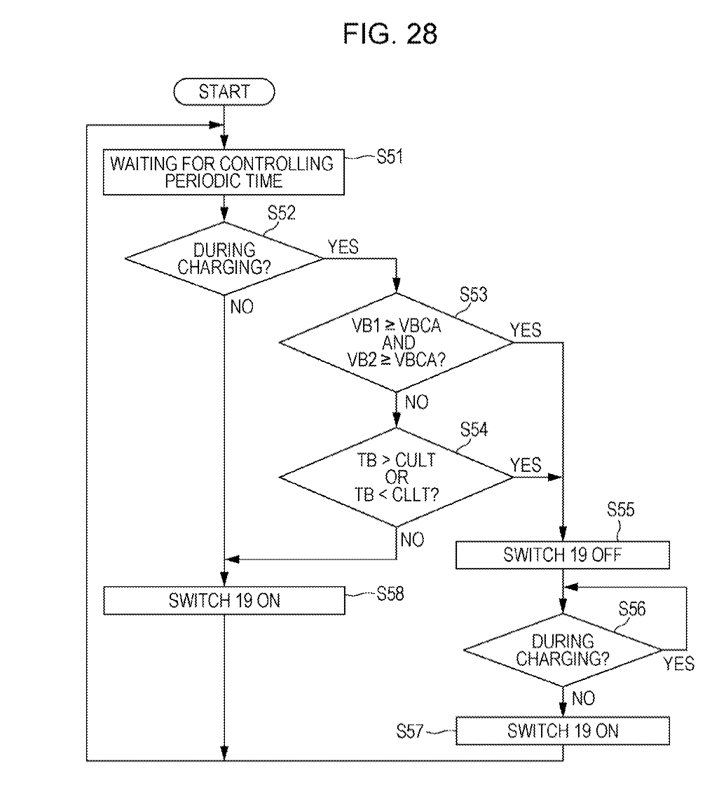

First of all, the flow of the controlling process of the switch 19 shown in the step S41 will be described with reference to FIG. 28. Herein, the description is, for example, given for a case where the third controlling method of the switch 19 described above is used. At step S51, it is waited for the predetermined control period time, and at the point of time when the control period time is reached, a transition into the process after a step S52 is performed.

At the step S52, it is judged whether or not charging is taking place. The judgment of whether or not charging is taking place is performed by the use of any one method of the above-described first to seventh judgment methods. If it is judged that charging is taking place, the process is transformed into a step S53. On the other hand, if it is judged that charging is not taking place, the process is transformed into a step S58, and the switch 19 is ON.

At the step S53, the cell voltages VB1 and VB2 of the batteries 11a and 11b are compared with the first charging upper limit battery voltage VBCA. As a consequence of the comparison, when the cell voltage VB1 is equal to or more than the first charging upper limit battery voltage VBCA or when the cell voltage VB2 is equal to or more than the first charging upper limit battery voltage VBCA, the process is transformed into a step S55.

On the other hand, if the condition indicated at the step S53 is not established, the process is transformed into a step S54. At the step S54, the sensor temperature TB is compared with the charging upper limit temperature CULT and the charge lower limit temperature CLLT. As a consequence of the comparison, when the sensor temperature TB is higher than the charging upper limit temperature CULT or when the sensor temperature TB is lower than the charge lower limit temperature CLLT, the process is transformed into a step S55.

At the step S55, the switches 19 is OFF, and at the next step S56, it is judged whether or not charging is taking place. If it is judged that charging is taking place, the process returns to the step S56, and it is judged whether or not charging is taking place again. If it is judged that charging is not taking place, the process returns to a step S57, and the switch 19 is ON. In addition, the process returns to the step S51.

On the other hand, if the condition at the step S54 is not established, the process is transformed into a step S58 and the switch 19 is ON.

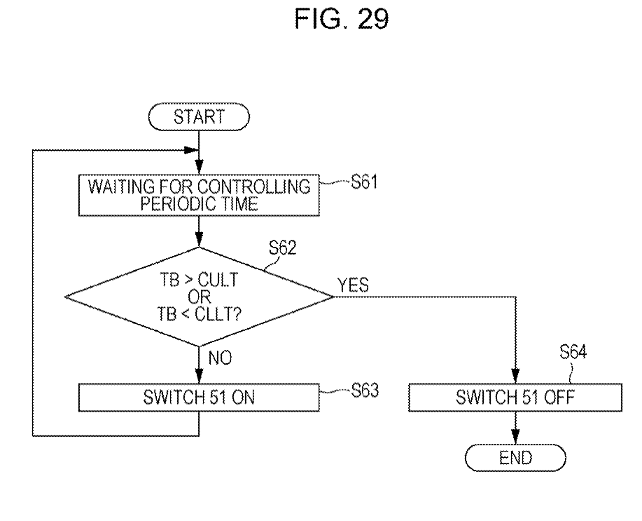

Next, the flow of the controlling process of the switch 51 shown in the step S42 will be described with reference to FIG. 29. Herein, the description is, for example, given for a case where the second controlling method of the switch 51 described above is used. At a step S61, it is waited for the predetermined control period time, and at the point of time when the control period time is reached, a transition into the process after a step S62 is performed.

At the step S62, the sensor temperature TB is compared with the charging upper limit temperature CULT and the charge lower limit temperature CLLT. As a consequence of the comparison, when the sensor temperature TB is higher than the charging upper limit temperature CULT or when the sensor temperature TB is lower than the charge lower limit temperature CLLT, the process is transformed into a step S64, the switch 51 is OFF, and a series of the processes is finished.

On the other hand, if the condition indicated at the step S62 is not established, the process is transformed into a step S63, and the switch 51 is ON. In addition, the process returns to the step S61.

As described above, in the third embodiment of the invention, by controlling the switch 19 and the switch 17 and the switch 51 according to the temperature, it is possible to charge so that the cell voltages VB1 and VB2 of the batteries 11a and 11b do not exceed the predetermined voltage such as the overcharge detection voltage.

Furthermore, by turning the switch 51 OFF according to the temperature so as to prohibit the charge, it is possible to prevent the deterioration of the battery 11 due to the abnormal high temperature and the damage of the elements such as the resistance portion 20.

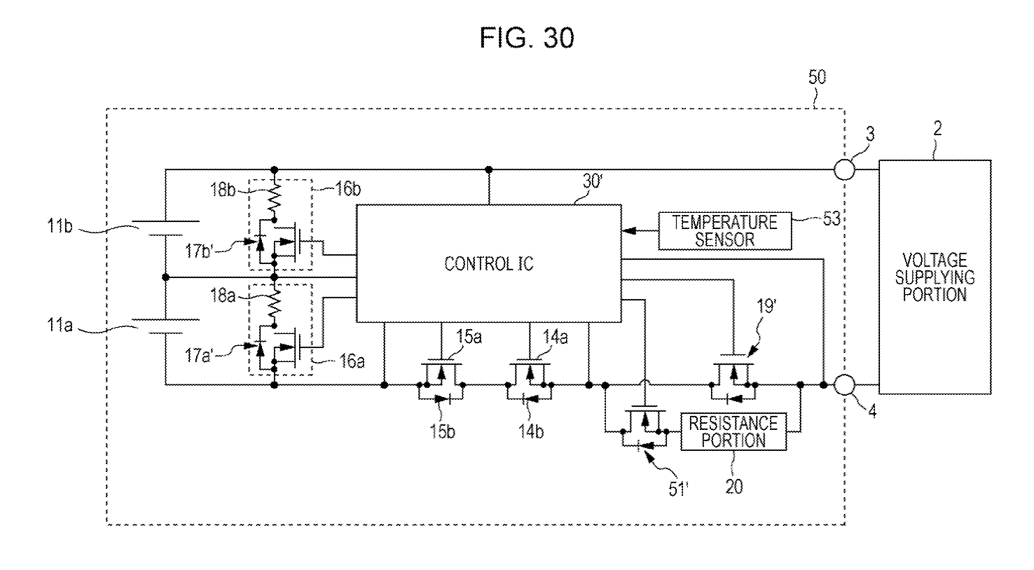

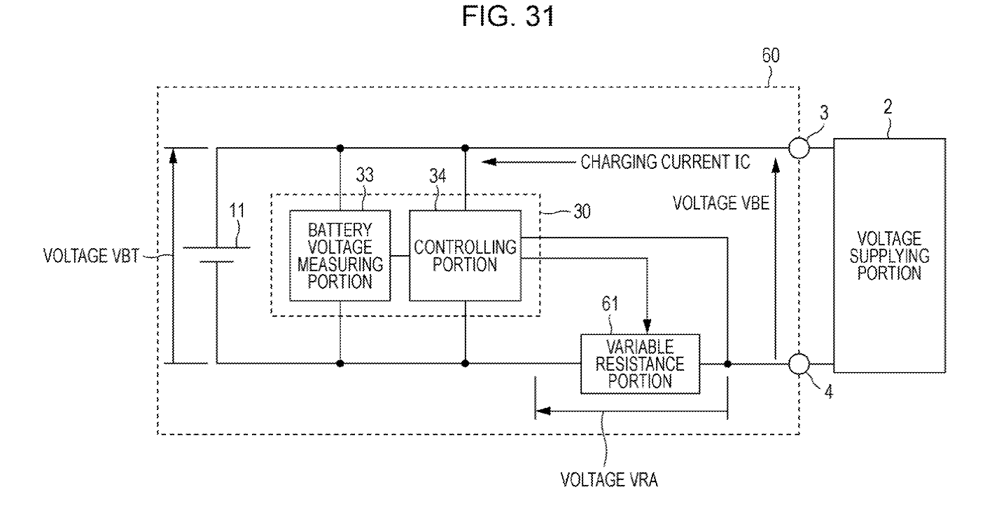

In addition, in the battery pack 50 according to the third embodiment, as the switch 19, the switch 17 and the switch 51, it is possible to use the switch 19′ the switch 17′ and the switch 51′ which use the FET as shown in FIG. 30, for example. Furthermore, even with respect to another stitch such as the switch 41, which is used in the first and second embodiments, similarly, it is possible to use the FET.

### 4. Fourth Embodiment

A fourth embodiment of the invention will be described. In the fourth embodiment, in place of the switch 19 and the resistance portion 20 which are installed in the path of the charging current in the above-described first embodiment, a variable resistance portion is installed. In addition, when the voltage of the secondary battery exceeds the predetermined charging upper limit battery voltage, the resistance value of the variable resistance portion is changed, which causes the charging voltage applied to the secondary battery to lower, whereby the charge of the secondary battery is made within the scope not exceeding the predetermined voltage.

Structure of Battery Pack

FIG. 31 shows a structure of one example of a battery pack 60 according to the fourth embodiment of the invention. In the battery pack 60, in place of the switch 19 and the resistance portion 20 which are connected and installed in parallel with the battery pack 1 according to the first embodiment shown in FIG. 2, a variable resistance portion 61 is installed. In addition, the control IC 30 includes a battery voltage measuring portion 33 and a controlling portion 34. Furthermore, the portions common to FIG. 2 are denoted by the same numbers and the descriptions thereof will be omitted.

The battery voltage measuring portion 33 measures the cell voltage of the battery 11 and supplies the controlling portion 34 with the same. The controlling portion 34 controls the resistance value of the variable resistance portion 61 on the basis of the measured cell voltage of the battery 11. The variable resistance portion 61 is installed between the minus terminal of the battery 11 and the negative pole terminal 4. By means of the control of the controlling portion 34, the variable resistance portion 61 is set to be a low resistance value at the time of the normal operation, and when the cell voltage of the battery 11 exceeds the first charging upper limit battery voltage, the variable resistance portion 61 is set to be a resistance value higher than the normal operation.

Charging Controlling Method

The charging controlling method of the battery pack 60 according to the fourth embodiment of the invention will be described. In the fourth embodiment, the resistance value of the variable resistance portion 61 is controlled on the basis of the cell voltage of the battery 11 and the charging performed so that the maximum cell voltage at the time of the charge does not exceed the predetermined certain set voltage.

At the time of the normal operation, the variable resistance portion 61 is set to be a low resistance value. During charging, if the predetermined condition is established for the cell voltage of the battery 11, the variable resistance portion 61 is set to be a resistance value higher than the normal operation by means of the control of the controlling portion 34. As the resistance value setting condition of the variable resistance portion 61, the same conditions as the conditions indicated in the first and the second controlling methods of the switch 19 described above are applicable. That is, when the cell voltage VBT of the battery 11 exceeds the first charging upper limit battery voltage VBCA, the variable resistance portion 61 is set to be a high resistance value.

When the voltage supplying portion 2 is connected to the battery pack 60 to perform the charging, the cell voltage VBT of the battery 11 is calculated from the following formula (21) on the basis of the resistance value RA and the charging current IC of the variable resistance portion 61.

VBT=VBE−RA×IC (21)

By setting the variable resistance portion 61 at a high resistance value, the amount of the voltage drop in the variable resistance portion 61 is increased, so that the voltage to be applied to the battery 11 is lowered and the maximum cell voltage at the time of the charging can be suppressed below the set voltage.

For example, the consideration will be given to a case where the direct current power supply, which is the voltage supplying portion 2 and has the maximum voltage of 4.3 V and the maximum current of 500 mA, is connected to the battery pack 60 which has the discharge capacity of about 530 mAh and the opening voltage of 3.1 V. In this example, the first charging upper limit battery voltage VBCA is set to be 4.21 V and it is set so that the charging is finished at the point of time when the charging current becomes below about 100 mA. In addition, as the variable resistance portion 61, the resistance in which the resistance value can be switched between about 270 mΩ and about 1.1Ω is applied.

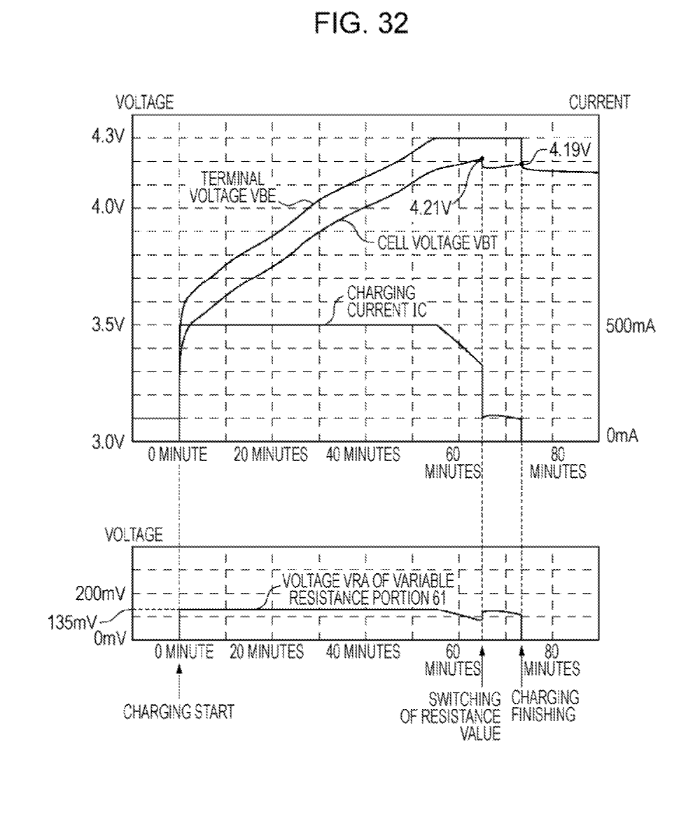

For each case, as shown in FIG. 32, after about 65 minutes from the charging start, the cell voltage VBT reaches 4.21 V which is the first charging upper limit battery voltage VBCA, the resistance value RA of the variable resistance portion 61 can be switched from about 270 mΩ to 1.1Ω, and this state is maintained until the charging is finished. In addition, after about 74 minutes from the charging start, the charging current IC becomes below about 100 mA and the charging is finished, and at this time, the amount of the voltage drop VRA in the variable resistance portion 61 is 0.11 V. As a result, the cell voltage VBT of the battery 11 is 4.19 V which is calculated by the subtraction of the amount of the voltage drop VRA due to the variable resistance portion 61 from the terminal voltage VBE. Thus, by controlling the resistance value of the variable resistance portion 61 based on the cell voltage, it is possible to control the maximum cell voltage below the set voltage (4.25 V).

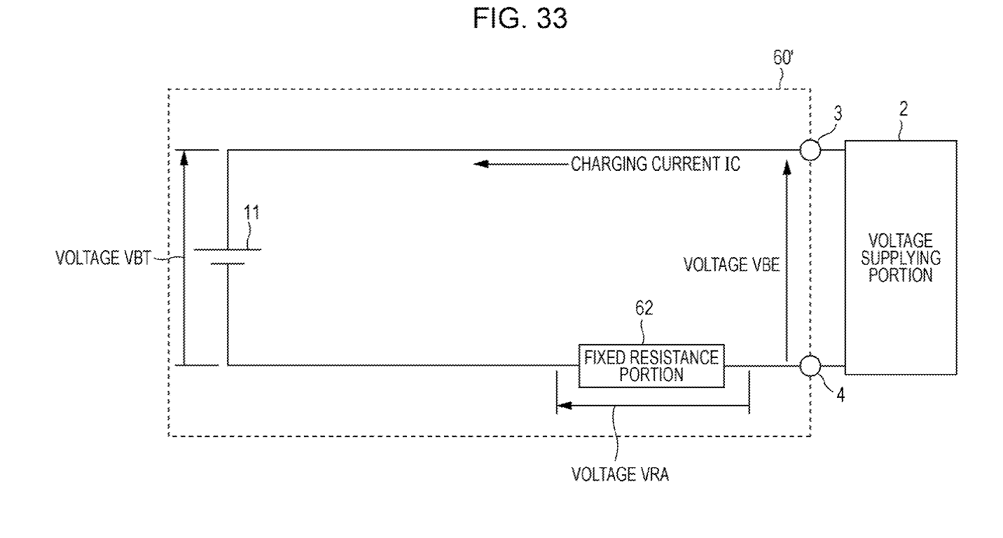

Herein, in order to facilitate the understanding about the fourth embodiment of the invention, as shown in FIG. 33, a battery pack 60′ in which a fixed resistance portion 62 having a fixed resistance value is installed in pace of the variable resistance portion 61 will be described. In this example, similar to the above-described fourth embodiment, the direct power source, which is voltage supplying portion 2 and has the maximum voltage of 4.3 V and the maximum current of 500 mA, is connected to the battery pack 60′ which has the discharge capacity of about 530 mAh and the opening voltage of 3.1 V. In addition, it is set so that the charging is finished at the point of time when the current voltage becomes about below 100 mA. Furthermore, as the fixed resistance portion 62, the resistance having the resistance value of about 190 mΩ is applied.

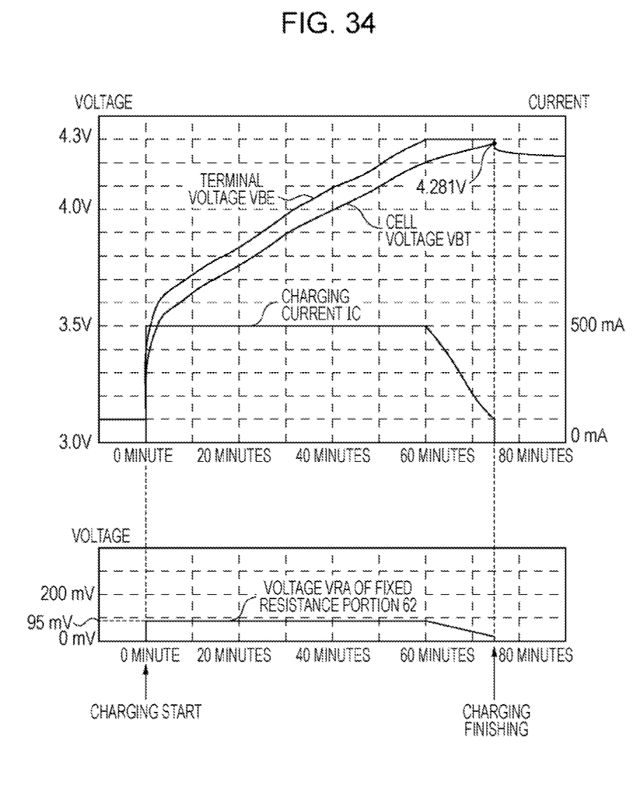

For each case, as shown in FIG. 34, after about 75 minutes from the charging start, the charging current becomes below about 100 mA and the charging is finished. At this time, the amount of the voltage drop VRA in the fixed resistance portion 62 becomes 19 mV. As a result, the cell voltage VBT of the battery 11 is 4.281 V, which is calculated by the subtraction of the amount of the voltage drop VRA due to the fixed resistance portion 62 from the terminal voltage VBE, and exceeds 4.25 V which is the set voltage. Thus, when the fixed resistance portion 62 is installed in the path of the charging current, it is difficult to control the cell voltage of the battery 11 below the set voltage.

As described above, in the fourth embodiment of the invention, by controlling the variable resistance portion 61, it is possible to perform the charge so that the cell voltage of the battery 11 does not exceed the predetermined set voltage. In addition, the structure according to the fourth embodiment is also capable of being combined with the first to third embodiments described above and applied.

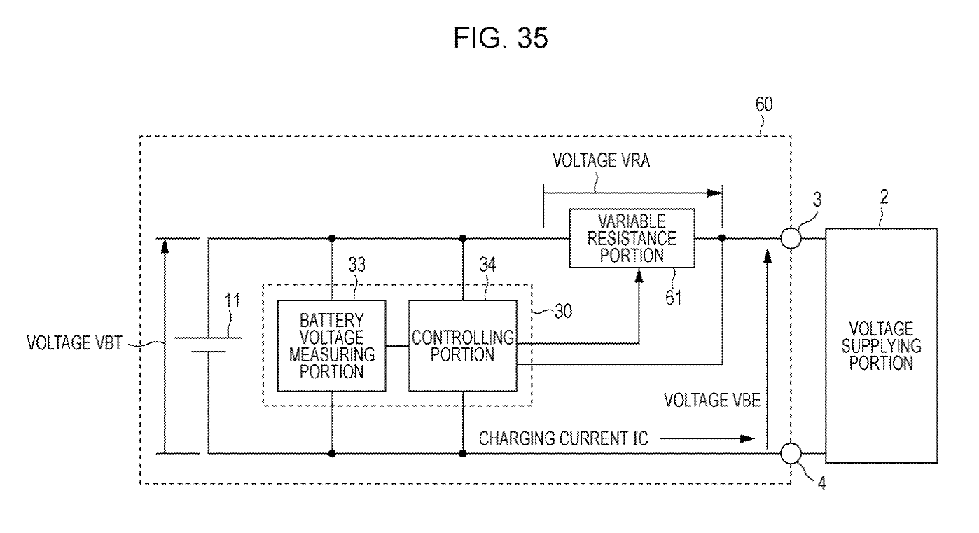

In addition, in this example, the description is given to the case where the variable resistance portion 61 is installed between the minus terminal of the battery 11 and the negative pole terminal 4, but not limited to this example, for example, as shown in FIG. 35, the variable resistance portion 61 may be installed between the plus terminal of the battery 11 and the positive pole terminal 3. Furthermore, in this example, the description is given to the case where one battery 11 is used, but even a case where a plurality of the batteries is used can be similarly applied.

### 5. Fifth Embodiment

A fifth embodiment of the invention will be described. In the fifth embodiment of the invention, the switch and the resistance portion, which are connected in series with each other, are installed between external electrode terminals. In addition, when the voltage of the secondary battery exceeds the predetermined charging upper limit battery voltage, the switch is ON so as to flow the charging current via the resistance portion, thereby performing the charge within the scope in which the voltage of the secondary battery does not exceed the predetermined voltage.

Structure of Battery Pack

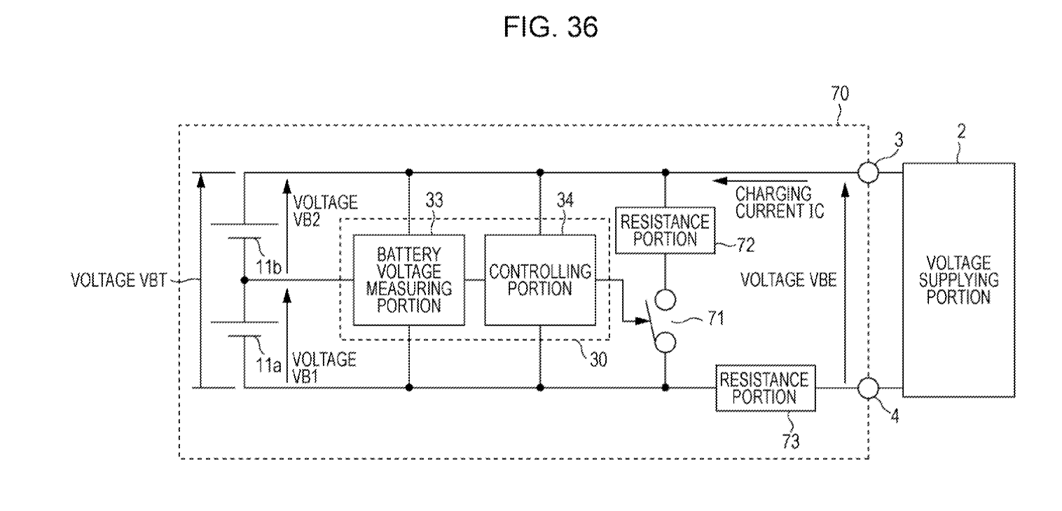

FIG. 36 shows a structure of one example of a battery pack 70 according to a fifth embodiment of the invention. In the battery pack 70, a resistance portion 73 is installed between the minus terminal of the battery 11a and the negative pole terminal 4, and a switch 71 and a resistance portion 72 are connected in series and installed between the minus terminal side of the battery 11a in the resistance portion 73 and the positive pole terminal 3. In addition, similar to the fourth embodiment, the control IC 30 includes the battery voltage measuring portion 33 and the controlling portion 34. Furthermore, the portions common to FIGS. 2 and 31 are denoted by the same numerals and the detailed descriptions thereof will be omitted.

The switch 71 is controlled by the controlling portion 34 and, when the cell voltages of the batteries 11a and 11b is equal to or less than the predetermined voltage, the switch 71 is OFF. When any one cell voltage of the batteries 11a and 11b exceeds the predetermined voltage, the controlling portion 34 switches the switch 71 from OFF to ON.

Charging Controlling Method

The charging controlling method of the battery pack 70 according to the fifth embodiment of the invention will be described. In the fifth embodiment, the switch 71 is controlled based on the cell voltages of the batteries 11a and 11b and the charging is performed so that the maximum cell voltage at the time of the charging does not exceed the predetermined certain set voltage.

At the time of the normal operation, the switch 71 is OFF. During charging, if any one cell voltage of the batteries 11a and 11b exceeds the predetermined voltage, the switch 71 is ON by the control of the controlling portion 34. As a condition for turning the switch 71 ON, the same condition as indicated in the first and second controlling methods of the switch 19 in the above-described first embodiment can be applied. That is, when any one of the cell voltages VB1 and VB2 of the batteries 11a and 11b exceeds the first charging upper limit battery voltage VBCA, the witch 71 is ON. The switch 71 is ON, so that the charging current flows in the resistance portion 72 connected in series to the switch 71, whereby it is possible to lower the voltages of the batteries 11a and 11b.

Lowering voltages AVBT of the battery voltages VBT of the batteries 11a and 11b, which is lowered by turning the switch 710N, is calculated the following formula (22) based on the resistance value RA of the resistance portion 73 and the resistance value RB of the resistance portion 72.

ΔVBT={(VB1+VB2)/RB}×RA (22)

For example, the consideration is given for a case the first charging upper limit battery voltage VBCA is set to be 4.21 V, the resistance value RA of the resistance portion 72 is 100 mΩ and the resistance value RB of the resistance portion 73 is 100Ω. In this case, when the cell voltages VB1 and VB2 of the batteries 11a and 11b become 4.21 V, the switch 71 is ON and the battery voltage VBT of the battery 11 is lowered. At this time, the lowering voltage ΔVBT of the battery voltage VBT becomes 8.42 mV based on the formula (22).

In this manner, in the fifth embodiment of the invention, by controlling the switch 71, it is possible to perform the charge so that the cell voltages of the batteries 11a and 11b do not exceed the predetermined set voltage. In addition, it is also possible for the structure according to the fifth embodiment to be combined with the above-described first to fourth embodiments and applied.

### EMBODIMENTS

Hereinafter, a battery pack according to a first embodiment of the invention is specifically described by way of embodiments, but the first embodiment is not limited only to the embodiments.

### First Embodiment

First of all, as described hereinafter, the battery 11a having the remaining discharge capacity of 10% was manufactured. The battery 11a having the discharge capacity of 1500 mAh was connected to a load and was discharged at 150 mA until the voltage became 2.3 V. This discharging was repeated until the opening voltage of the battery 11a became below 3.0 V. In addition, the battery 11a was connected to the direct current power source and was charged for 60 minutes at the charging current of 150 mA so that the maximum voltage became 4.2 V. In this manner, the battery 11a having the discharging capacity of 150 mAh, that is, the remaining discharging capacity of 10% was manufactured.

Then, as described hereinafter, the battery 11b having the remaining discharging capacity of 0% was manufactured. The battery 11b having the discharging capacity of 1500 mAh was connected to the load and was discharged at 150 mA until the voltage became 2.3 V. The discharging was repeated until the opening voltage of the battery 11b became below 3.0 V. In this manner, the battery 11b having the discharging capacity of 0 mAh, that is, the remaining discharging capacity of 0% was manufactured.

The batteries 11a and 11b thus manufactured were connected in series with each other so as to manufacture the battery pack shown in FIG. 2. Herein, it was assumed that the resistance value of the resistance portion 20 was 0.8Ω.

### Second Embodiment

Similar to the first embodiment, the battery 11a having the remaining discharging capacity of 10% and the battery 11a having the remaining discharging capacity of 0% were manufactured. In addition, the batteries 11a and 11b thus manufactured are connected in series with each other so as to manufacture the battery pack shown in FIG. 10. Herein, it was assumed that the resistance value of the resistance portion 20 was 0.8Ω and the resistance values of the resistance portions 18a and 18b were 120Ω.

### First Comparison Example

Similar to the first embodiment, the battery 11a having the remaining discharging capacity of 10% and the battery 11a having the remaining discharging capacity of 0% were manufactured. In addition, the battery pack was produced in which the batteries 11a and 11b thus manufactured are connected in series with each other.

### Second Comparison Example

Similar to the manufacturing method of the battery 11b in the first embodiment, the batteries 11a and 11b having the remaining discharging capacities of 0% were manufactured. In addition, the battery pack was produced in which the batteries 11a and 11b thus manufactured were connected in series with each other.

Measurement of Charging Property

With respect to the battery packs of the first embodiment, the second embodiment, the first comparison example and the second comparison example manufactured as described above, the direct current in which the maximum voltage and the maximum current are limited to 8.4 V and 1.2 A was connected so as to performing the charging of the electrostatic current and the electrostatic voltage. In addition, when the charging current became about 42 mA, the charging was finished.

In the first and second embodiments, when the cell voltages VB1 and VB2 of the batteries 11a and 11b become equal to or more than the first charging upper limit battery voltage VBCA, the switch 19 is OFF and the OFF-state is maintained until the charging is finished. Herein, in the first and second embodiments, it was assumed that the first charging upper limit battery voltage VBCA was 4.19 V.

In the second embodiment, when the cell voltage VB1 is equal to or more than the second charging upper limit battery voltage VBCB or when the voltage difference VB1−VB2 of the cell voltages VB1 and VB2 is equal to or more than the upper limit battery voltage difference VBDL, the switch 17a is ON and the ON-state is maintained for the maintenance time. In addition, when the cell voltage VB2 is equal to or more than the second charging upper limit battery voltage VBCB or when the voltage difference VB2−VB1 of the cell voltages VB2 and VB1 is equal to or more than the upper limit battery voltage difference VBDL, the switch 17b is ON and the ON-state is maintained for the maintenance time. Herein, in the second embodiment, it was assumed that the second charging upper limit battery voltage VBCB was 4.19 V, the upper limit battery voltage difference VBDL was 20 mV, and the maintenance time of the switches 17a and 17b was 60 seconds.

In the charging of the battery pack, there were measured the cell voltages VB1 and VB2 of the batteries 11a and 11b at predetermined points of times A to E, the cell voltage differences VB1-VB2 and VB2−VB1, the charging current IC, and the voltage VRA of the resistance portion 20. Herein, the point of time A is a point of time just before the switch 19 is OFF. The point of time B is a point of time when 3 minutes have passed after the switch 19 was OFF. The point of time C is a point of time just before the charging has been finished. The point of time D is a point of time when the charging has been finished. The point of time E is a point of time when 20 minutes have passed after the charging was finished. At this time, the cell voltages VB1 and VB2 of the batteries 11a and 11b which are equal to or less than 4.25 V were used as the standard of the judgment whether or not it was passed.

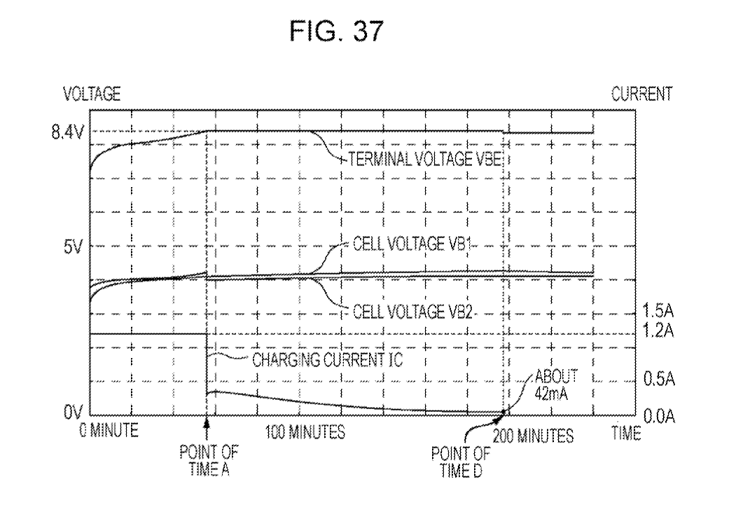

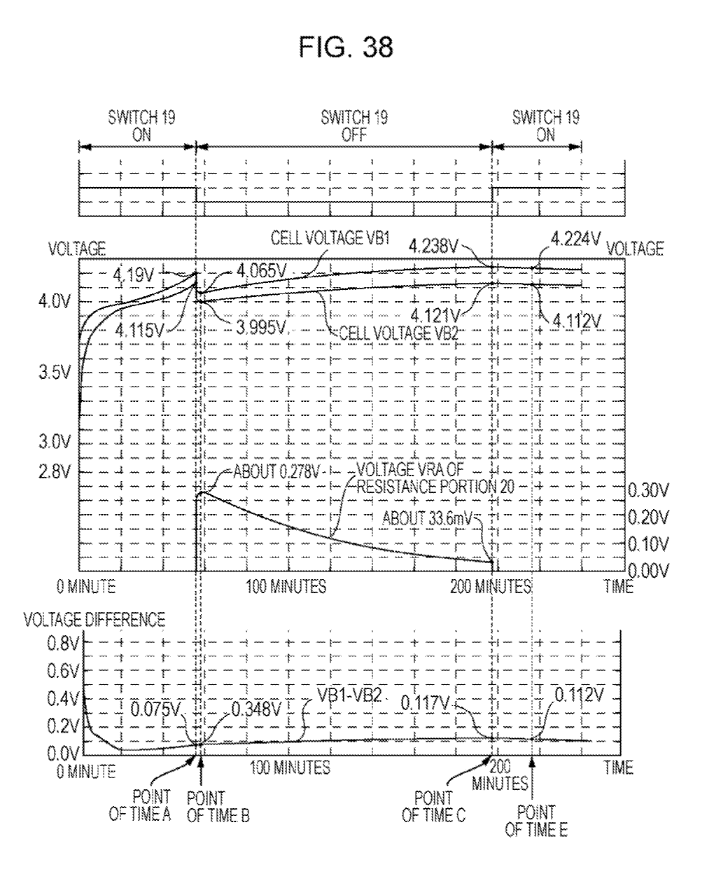

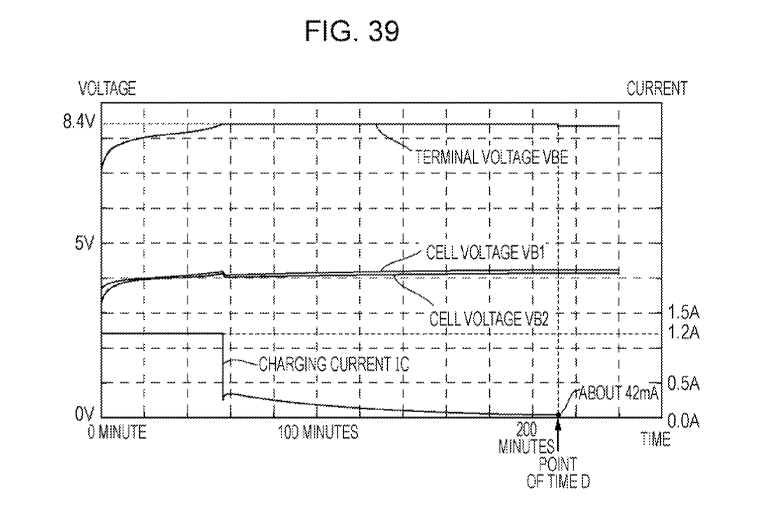

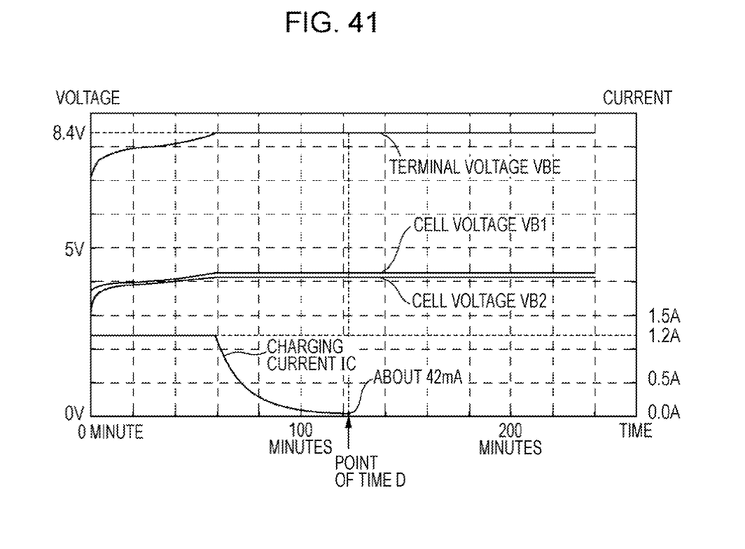

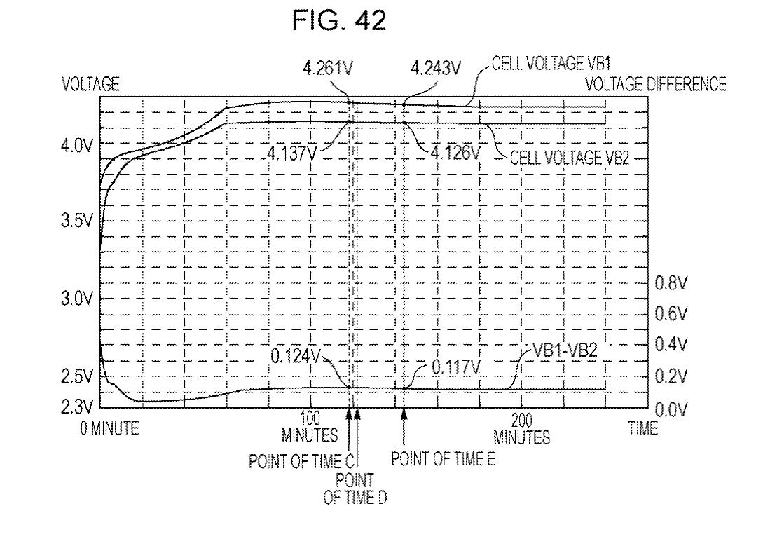

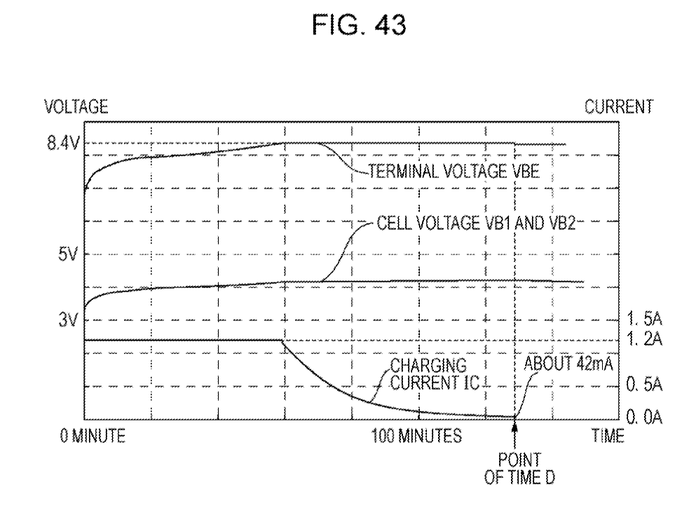

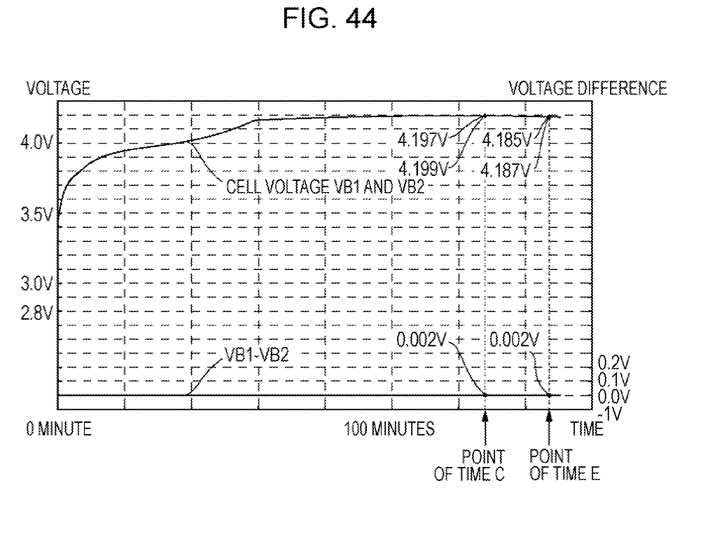

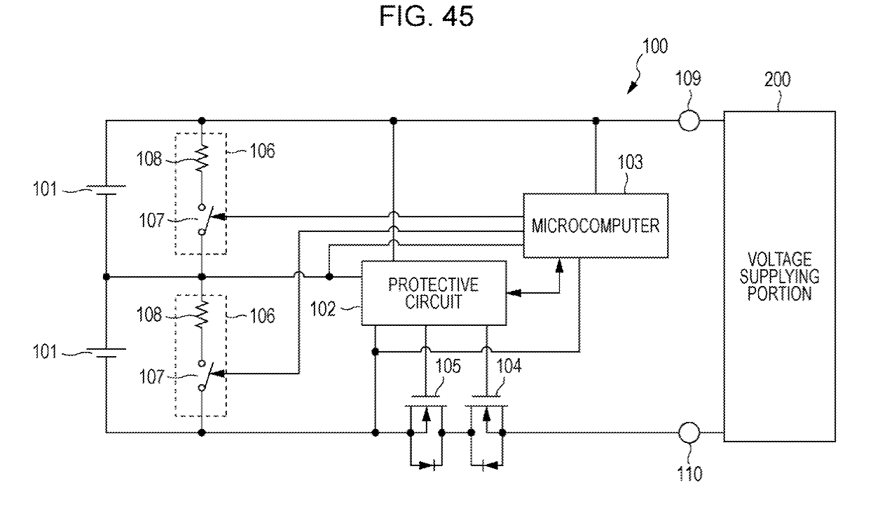

With respect to the first embodiment, the battery packs of the second embodiment, the first comparison example and the second comparison example manufactured as described above, the measurement results at each of the points of times A to E are shown in FIGS. 37 to 44 and Table 1. In addition, since in the second embodiment, the cell voltage VB2 is lower than the cell voltage VB1 and the switch 17b is not operated, the operation of the switch 17b is not described in the measurement results. Furthermore, since resistance portion 20 is not installed in the first and second comparison examples, there is no article of the voltage VRA of the resistance portion 20. Furthermore, since the switch 19 is not installed in the first and second comparison examples, the measurements at the points of times A and B are not performed.

TABLE 1

| | Point of Time A | | | | | Point of Time B | | | | |
|---|---|---|---|---|---|---|---|---|---|---|
| | | | VB1 − | | | | | VB1 − | | |
| | VB1 | VB2 | VB2 | IC | VRA | VB1 | VB2 | VB2 | IC | VRA |
| First | 4.190 V | 4.115 V | 75 mV | 1.2 A | 0 V | 4.065 V | 3.995 V | 70 mV | 348 mA | 278 mV |
| embodiment | | | | | | | | | | |
| Second | 4.190 V | 4.122 V | 68 mV | 1.2 A | 0 V | 4.065 V | 4.002 V | 63 mV | 341 mA | 273 mV |
| embodiment | | | | | | | | | | |
| First | — | — | — | — | | — | — | — | — | |
| comparison | | | | | | | | | | |
| example | | | | | | | | | | |
| Second | — | — | — | — | | — | — | — | — | |
| comparison | | | | | | | | | | |
| example | | | | | | | | | | |

| | Point of Time C | | | | | Point of Time D | | | | |
|---|---|---|---|---|---|---|---|---|---|---|
| | | | VB1 − | | | | | VB1 − | | |
| | VB1 | VB2 | VB2 | IC | VRA | VB1 | VB2 | VB2 | IC | VRA |
| First | 4.238 V | 4.121 V | 117 mV | 42 mA | 33.6 mV | 4.224 V | 4.112 V | 112 mV | — | — |
| embodiment | | | | | | | | | | |
| Second | 4.220 V | 4.141 V | 79 mV | 42 mA | 33.6 mV | 4.213 V | 4.134 V | 79 mV | — | — |
| embodiment | | | | | | | | | | |
| First | 4.261 V | 4.137 V | 124 mV | 42 mA | | 4.234 V | 4.126 V | 117 mV | — | |
| comparison | | | | | | | | | | |
| example | | | | | | | | | | |
| Second | 4.197 V | 4.199 V | 2 mV | 42 mA | | 4.185 V | 4.187 V | 2 mV | — | |
| comparison | | | | | | | | | | |
| example | | | | | | | | | | |

From the results, in the first embodiment, the cell voltages VB1 and VB2 of the batteries 11a and 11b at the point of time C just before the charging has been finished became the maximum cell voltages. In this manner, by turning the switch 19 OFF so as to flow the current in the resistance portion 20, it is possible to make the cell voltages VB1 and VB2 below 4.25 V.

Herein, the charging current IC at the point of time B when 3 minutes have passed after the switch 19 was OFF is 348 mV and the voltage VRA of the resistance portion 20 is 278 mV. That is, by turning the switch 19 OFF, the voltage drop due to the resistance portion 20 is 278 mV, so that the voltage applied to the batteries 11a and 11b can be reduced by 278 mV.

In the second embodiment, like the first embodiment, the cell voltages VB1 and VB2 of the batteries 11a and 11b at the point of time C just before the charging was finished became the maximum cell voltage.

As described above, the switch 19 is OFF so as to flow the current in the resistance portion 20 and at the same time the switches 17a and 17b are ON so as to flow the current in the cell balance circuits 16a and 16b, so that the cell voltages VB1 and VB2 can be equal to or less than 4.25 V.

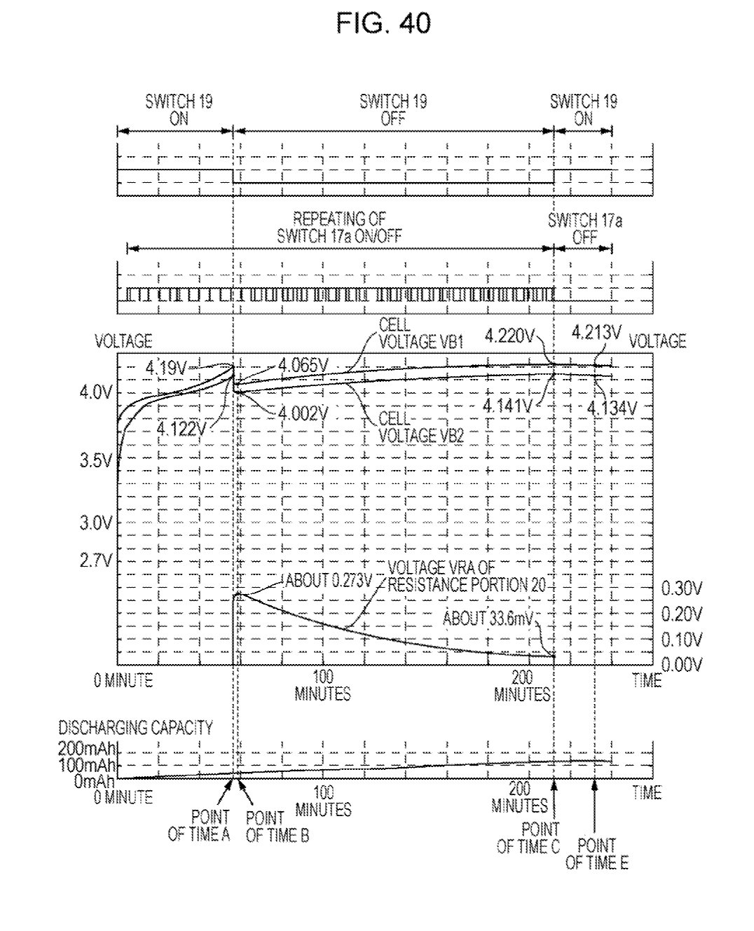

In addition, as shown in FIG. 40, the discharging capacity in the resistance portion 18a is 119 mAh, and it is possible to reduce the difference by about 79% with respect to 150 mAh which is a difference in the discharging capacities before the charging.

Herein, the charging current IC at the point of time B when 3 minutes have passed after the switch 19 was OFF is 341 mV, and the voltage VRA of the resistance portion 20 is 273 mV. That is, by turning the switch 19 OFF, the voltage drop due to the resistance portion 20 is 273 mV, so that the voltage applied to the batteries 11a and 11b can be reduced by 273 mV.

Furthermore, in the second embodiment, by turning the switches 17a and 17b ON, it is possible to reduce the maximum cell voltage by 18 mV compared with the first embodiment, so that the cell voltage can be more efficiently controlled.

On the other hand, in the first comparison example, the cell voltage VB1 of the battery 11a at the point of time C just before the charging is finished becomes the maximum cell voltage (4.261 V), so the cell voltage exceeds 4.25 V. In addition, in the second comparison example, the cell voltages VB1 and VB2 of the batteries 11a and 11b at the point of time C just before the charging is finished became the maximum cell voltage. In this manner, when there is no difference in the remaining discharging capacities of the batteries 11a and 11b, the cell voltages VB1 and VB2 can be equal to or less than 4.25 V.

From the above-described result, in order to make the cell voltage when there is a difference in the remaining discharging capacities below 4.25 V, it is necessary to control the switch 19. In addition, by controlling the switches 17a and 17b and reducing the difference in the remaining discharging capacities of the battery, the cell voltage can be more effectively controlled.

While the first to fifth embodiments of the invention have been described above, the invention is not limited to the above-described first to fifth embodiments of the invention, but various modifications and applications can be made within the scope without departing from the gist of the invention. For example, in the above-described examples, it has been described that the resistance portion 20 is installed between the minus terminal of the battery 11 and the negative pole terminal 4, but not limited thereto, for example, the resistance portion 20 may be installed between the plus terminal of the battery 11 and the positive pole terminal 3.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

1. A battery pack comprising:
one or a plurality of secondary batteries that are connected with each other;
a positive pole terminal and a negative pole terminal to which external equipment is connected;
a variable resistance portion which is connected between a positive pole of the secondary battery and the positive pole terminal or between a negative pole of the secondary battery and the negative pole terminal and resistance values of which are changed;
a battery voltage measuring portion for measuring the voltage of the secondary battery; and
a controlling portion for controlling the resistance value of the variable resistance portion based on the measurement result of the battery voltage measuring portion.

2. A battery pack comprising:
one or a plurality of secondary batteries that are connected with each other;
a positive pole terminal and a negative pole terminal to which external equipment is connected;
a first switch which is connected between a positive pole of the secondary battery and the positive pole terminal or between a negative pole of the secondary battery and the negative pole terminal;
a first resistance portion which is connected in parallel to the first switch;
a battery voltage measuring portion for measuring the voltage of the secondary battery; and
a controlling portion for controlling an open state and a connection state of the first switch based on the measurement result of the battery voltage measuring portion.

3. A battery pack comprising:
one or a plurality of secondary batteries that are connected with each other;
a positive pole terminal and a negative pole terminal to which external equipment is connected;
a first switch which is connected between a positive pole of the secondary battery and the positive pole terminal or between a negative pole of the secondary battery and the negative pole terminal;
a first resistance portion which is connected in parallel to the first switch;
a battery voltage measuring portion for measuring the voltage of the secondary battery; and
a controlling portion for controlling an open state and a connection state of the first switch based on the measurement result of the battery voltage measuring portion,
wherein when at least one voltage of the one or a plurality of secondary batteries is equal to or more than a predetermined first charging upper limit battery voltage, the controlling portion switches the first switch to the open state so as to flow the charging current, which is supplied from an external voltage supplying portion connected to the positive terminal and the negative terminal, to the secondary battery via the first resistance portion.

4. The battery pack according to claim 1, further comprising:
a current detecting resistance portion which is connected between the positive pole of the secondary battery and the positive pole terminal or between the negative pole of the secondary battery and the negative pole terminal; and
a voltage measuring portion for detecting the current which measures the voltages of both ends of the current detecting resistance portion,
wherein in a case where the current detecting resistance portion is connected between the positive pole of the secondary battery and the positive pole terminal, the voltage measuring portion for detecting the current sets the voltage of the terminal of the positive pole side of the secondary battery in the current detecting resistance portion to be a standard potential,
wherein the current detecting resistance portion is connected between the negative pole of the secondary battery and the negative pole terminal, the voltage measuring portion for detecting the current sets the voltage of the terminal of the negative pole terminal side in the current detecting resistance portion to be a standard potential,
wherein in a case where the voltages of both ends of the current detecting resistance portion are equal to or more than a predetermined charging judgment voltage, the voltage measuring portion for detecting the current judges that charging is taking place,
wherein in a case where the voltages of both ends of the current detecting resistance portion are less than a predetermined charging judgment voltage, the voltage measuring portion for detecting the current judges that charging is not taking place, and
wherein, as a consequence of the judgment, in the case of charging, the control by the controlling portion is performed.

5. The battery pack according to claim 1, wherein
the battery voltage measuring portion measures the voltages of the one or plurality of secondary batteries twice or more for each predetermined period,
in a case where a value, which has been calculated by the subtraction of the voltage of the secondary battery measured before one period from the voltage of the secondary battery measured at a predetermined time, is a positive value, the battery voltage measuring portion judges that charging is taking place,
in a case where a value, which has been calculated by the subtraction of the voltage of the secondary battery measured before one period from the voltage of the secondary battery measured at a predetermined time, is a negative value, the battery voltage measuring portion judges that charging is not taking place, and
in the case of charging, the control by the controlling portion is performed.

6. The battery pack according to claim 1 wherein
the battery voltage measuring portion measures the voltages of the one or plurality of secondary batteries three times for each predetermined period,
in a case where a value, which has been calculated by the subtraction of the voltage of the secondary battery measured before one period from the voltage of the secondary battery measured at a predetermined time, is equal to or more than a predetermined judgment differential value, or a value, which has been calculated by the subtraction of the voltage of the secondary battery measured before two period from the voltage of the secondary battery measured before the one period, is equal to or more than the predetermined judgment differential value, the battery voltage measuring portion judges that charging is taking place,
in a case where a value, which has been calculated by the subtraction of the voltage of the secondary battery measured before one period from the voltage of the secondary battery measured at the predetermined time, is equal to or less than a predetermined judgment differential value, and a value, which has been calculated by the subtraction of the voltage of the secondary battery measured before the two period from the voltage of the secondary battery measured before the one period, is equal to or less than the predetermined judgment differential value, the battery voltage measuring portion judges that charging is not taking place, and
in the case of during charging, the control by the controlling portion is performed.

7. The battery pack according to claim 1 further comprising:
one or a plurality of first discharging controlling portions that includes a series connection of a second switch and a second resistance portion,
wherein the first discharging controlling portion is each connected in parallel to the one or a plurality of secondary batteries, and
wherein in a case where any one of the voltages of the one or a plurality of secondary batteries, which have been measured by the battery voltage measuring portion during charging, is equal to or more than a predetermined second charging upper limit battery voltage, the controlling portion switches the corresponding second switch to a connection state so as to discharge the secondary battery via the second resistance portion.

8. The battery pack according to claim 1 further comprising:
a plurality of first discharging controlling portions that includes a series connection of a second switch and a second resistance portion,
wherein the first discharging controlling portion is each connected in parallel to the plurality of secondary batteries, and
wherein in a case where a voltage difference of the plurality of secondary batteries, which have been measured by the battery voltage measuring portion during charging, is equal to or more than a predetermined upper limit battery voltage difference, the controlling portion switches the second switch to a connection state so as to discharge the secondary battery via the second resistance portion.

9. The battery pack according to claim 1 further comprising:
a second discharging controlling portion that includes a series connection of a third switch with a third resistance portion,
wherein the plurality of secondary batteries are connected in series with each other,
wherein the second discharging controlling portion is connected in parallel to the plurality of secondary batteries connected in series with each other,
wherein in a case where any one of the voltages of the plurality of secondary batteries, which have been measured by the battery voltage measuring portion, is equal to or more than a predetermined third charging upper limit battery voltage, the controlling portion switches the third switch to a connection state so as to discharge the secondary battery via the third resistance portion.

10. The battery pack according to claim 2 further comprising:
a temperature sensor that is disposed inside of the battery pack and measures the temperature of the inside of the battery pack,
wherein the controlling portion controls the first switch based on the temperatures which have been measured by the temperature sensor.

11. The battery pack according to claim 3 further comprising:
a temperature sensor that is disposed inside of the battery pack and measures the temperature of the inside of the battery pack,
wherein, the value of the first charging upper limit battery voltage, the second charging upper limit battery voltage or the third charging upper limit battery voltage is changed according to the temperatures which have been measured by the temperature sensor.

12. The battery pack according to claim 7 further comprising:
a temperature sensor that is disposed inside of the battery pack and measures the temperature of the inside of the battery pack,
wherein in a case where the temperature of the inside of the battery pack, which has been measured by the temperature sensor, exceeds a predetermined charging upper limit battery voltage, the controlling portion switches the second switch to an open state so as to shut off the current of the second resistance portion.

13. The battery pack according to claim 1 further comprising:
a temperature sensor that is disposed inside of the battery pack and measures the temperature of the inside of the battery pack; and
a fourth switch that is connected in series to the variable resistance portion or the first resistance portion,
wherein in a case where the temperature, which has been measured by the temperature sensor, exceeds a predetermined charging upper limit temperature, or in a case where the temperature is lower than a predetermined charging lower limit temperature, the controlling portion switches the fourth switch to an open state so as to shut off the charging current.

14. The battery pack according to claim 2 further comprising:
a temperature sensor that is disposed in the vicinity of the secondary battery and measures the temperatures of the secondary battery,
wherein in a case where the temperature of the secondary battery, which has been measured by the temperature sensor during charging, exceeds a predetermined charging upper limit temperature, or in a case where the temperature is lower than a predetermined charging lower limit temperature, or in a case where the voltage of the secondary battery is equal to or more than the first charging upper limit battery voltage, the controlling portion switches the first switch to an open state so as to flow the charging current via the first resistance portion.

15. The battery pack according to claim 2 wherein,
with respect to the first, second, and third resistance portions, temperature switch elements which are switched from the connection state to the open state at the predetermined temperature are connected in series.

16. The battery pack according to claim 2 wherein,
the first, second, and third resistance portions are elements in which fluctuation in resistance values due to fluctuation in the temperatures is small.

17. The battery pack according to claim 2 wherein,
the first, second, and third resistance portions are elements in which resistance values are increased as the temperature rises.

18. A charging method comprising:
measuring voltages of one or a plurality of secondary batteries connected with each other; and
switching a first switch, which is installed in a current path of a charging current flowing in the secondary battery, to an open state, in a case where the voltage of the secondary battery is equal to or more than a predetermined first charging upper limit battery voltage during charging, so as to flow the charging current via a first resistance portion connected in parallel to the first switch.
